(19) United States
(12) Patent Application Publication
(10) Pub. No.: US 2011/0043537 A1
(43) Pub. Date: Feb. 24, 2011

(54) VISUAL DISTORTION IN A VIRTUAL ENVIRONMENT TO ALTER OR GUIDE PATH MOVEMENT

(75) Inventors: Brian Dellon, Seattle, WA (US); Yoky Matsuoka, Medina, WA (US)

Correspondence Address: Law Offices of Ronald M. Anderson, 600 108th Ave NE, Suite 507, Bellevue, WA, 98004, US

(73) Assignee: University of Washington, Seattle, WA (US)

(21) Appl. No.: 12/860,296

(22) Filed: Aug. 20, 2010

Related U.S. Application Data
(60) Provisional application No. 61/235,468, filed on Aug. 20, 2009.

(51) Int. Cl. G09G 5/00

(52) U.S. Cl. 345/647

(57) ABSTRACT

A safe, purely dissipative, robotic device and method for rehabilitation of large whole body movements, for example, in stroke victims. Shifting to passive actuation fundamentally changes common control strategies that work well for active devices. The novel approach distorts visual feedback to the subjects as a first step to achieve the desired controllability hereto limited by passivity constraints. With visual distortion, a subject's arm trajectory can be altered in a way that passive actuation alone cannot. Results show that subjects involuntarily changed their path motion up to 30% with distortion applied. This ability to steer user's movements can be harnessed to offset controllability issues.

### RELATED APPLICATIONS

This application is based on a prior copending provisional application Ser. No. 61/235,468, filed on Aug. 20, 2009, the benefit of the filing date of which is hereby claimed under 35 U.S.C. §119(e).

### GOVERNMENT RIGHTS

This invention was made with government support under Grant No. R21HD47405-01 awarded by National Institutes of Health. The government has certain rights in the invention.

### BACKGROUND

The brain's ability to convolve multi-modal sensory information into a correct perception can be relied upon to affect a user's movement through false perception. In the nervous system, the combination of visual and haptic/movement information (sensory fusion) has been found to be similar to maximum likelihood estimation. It has been shown that visual feedback dominates sensory fusion when the variance associated with visual estimation is less than that of the haptic mode, due to the disparity between a person's acute visual feedback and dull kinesthetic (muscle) feedback. Thus, the human brain tends to rely more on visual cues than kinesthetic ones, even if the visual cues are providing false information.

Classic work to investigate sensory fusion has been conducted as early as the 1960's. In one study, spectacles fabricated using Risley prisms were used to shift a subject's gaze while the subject judged their hand position both visually and haptically. The results confirmed that the subjects perceived their hand position to be consistent with what was visually observed more than what was kinesthetically felt.

Simulated force feedback through the use of an isometric device similar to a computer mouse is related to sensory fusion and visual distortion. The force-feedback is perceived through the internal mechanical characteristics of the isometric device, in combination with force-controlled visual feedback. The result of this perception are referred to in the art as “pseudo-haptic feedback.” Experiments investigating pseudo-haptics tend to focus on the haptic analogues of visual illusions, such as the Bourdon or Muller-Lyer illusions.

While studies of sensory fusion, pseudo-haptics, and illusion are well documented, no evidence has been shown relating to their utility explicitly in the control mechanics of a virtual environment. The methods and phenomena discussed above are embodied through visual feedback distortion and its relevance for actively controlling a subject's perception with respect to the virtual environment.

It would be desirable to use contextual feedback distortion in a virtual robotic environment for rehabilitation using a phantom robotic device. The goal would be to increase hand strength and finger mobility in chronic stroke survivors through exercises beyond their perceived ability. This goal might be accomplished by manipulating a visual error feedback metric within the range dictated by both the position and force to produce just-noticeable differences of the index finger and thumb. The distorted feedback might push the subject to produce greater force or range of motion without their awareness. It is hoped that therapeutic results using this technique might show that subjects can learn to spread their fingers further with increased mobility, and become stronger because of the exposure to this virtual robotic environment.

Further, it would be desirable to use visual feedback distortion as a way to overcome some of the inherent limitations of the passive robotic environment, to include the entire arm. If a passive robotic environment is incapable of producing forces to redirect a user's movements, it is hoped that the visual feedback to the user can be distorted to redirect the limb's motion as a result of the brain's preference to rely on visual observation.

### SUMMARY

An exemplary method is set forth below for enhancing an interaction of a user with a machine. The method includes the step of enabling the user to control movement of a physical component of the machine, to accomplish a defined task. For example, the user might grasp a handle of the machine and move it in a specified manner to carry out a task. The movement of the physical component caused by the user is sensed, producing a signal that is indicative of the movement. In response to the signal, a virtual representing the defined task is displayed to the subject. One or more characteristics of the movement caused by the user in carrying out the task are distorted, as displayed to the user in the virtual representation. However, the extent of the distortion is limited such that distortion of the one or more characteristics is not perceived by the user. The user is encouraged to respond to the virtual representation for which the one or more characteristics were distorted, as viewed by the user, so that the user modifies the movement of the physical component based on a perception of the virtual representation by the user, due to the distortion of the one or more characteristics.

The machine can apply a frictional force to resist the movement of the physical component by the user in at least one plane. Further, the step of distorting the one or more characteristics can include the step of distorting at least one characteristic, such as by applying either a positive or a negative gain to the displayed representation of the motion of the physical component in the virtual representation relative to an actual motion of the physical component caused by the user; or by creating a visual feedback distortion in the virtual representation in at least one dimension, to distort the movement being represented therein by creating a displacement between the representation of a position of the physical component in the virtual representation displayed and a position at which the physical component is actually disposed; or by creating the visual feedback distortion in the virtual representation using an illusory motion of an element displayed in the virtual representation; or by creating the visual feedback distortion in the virtual representation by modifying the motion of an element representing the physical component so that the element visually appears to be acted upon by a force that is actually different than a force applied to they physical component by the machine.

The defined task can correspond to using the machine to assist the user in moving a physical load from one position to another. In this case, the user can respond to the distortion of the one or more characteristics of the movement in the virtual representation by controlling the physical component to achieve the movement of the physical load, so that at least one attribute of the machine appears to be enhanced to the user, based on the visual perception by the user of the movement that is displayed in the virtual representation.

The step of distorting the one or more characteristics of the movement caused by the user can include the step of distorting at least one characteristic selected from a group that includes: a speed of the movement visually displayed in the virtual representation; a velocity of the movement visually displayed in the virtual representation; an acceleration of the movement visually displayed in the virtual representation; a direction of the movement visually displayed in the virtual representation; an extent of the movement visually displayed in the virtual representation; and an illusory self movement of an element displayed in the virtual representation.

The step of enabling the user to control movement of the physical component of the machine can include the step of enabling the user to move the physical component with an appendage of the user.

The method can further include the step of implementing the virtual representation of the movement as part of a game in which the user is participating, so that the user is more willing to carry out the defined task.

The step of encouraging the user to respond to the virtual representation for which the one or more characteristics were distorted can include the step of repetitively causing the user to visually perceive in the virtual representation that less movement of the physical component occurred than was actually the case, so that the user responds by exerting more force to move the physical component than the user would otherwise have applied. In this way, the strength and mobility of the user can be increased.

The step of encouraging the user to respond to the virtual representation for which the one or more characteristics were distorted can also include the step of repetitively causing the user to visually perceive in the virtual representation that the representation of the movement of the physical component was in a different direction than the user actually moved the physical component. As a result, the user will be encouraged to respond by changing the direction in which the user tries to move the physical component, thereby enabling the user to better move an appendage of the user's body in a desired manner.

Another aspect of this approach is directed to a system for enhancing an interaction with a user. The system includes a movable component configured to be moved by a user when carrying out a defined task and having one or more sensors for detecting movement of the component by the user and producing an output signal indicative of the movement. A display is configured to enable the user to view a virtual representation of the movement while the user is carrying out the task, and a controller is coupled to receive the signal and operative to drive the display so that one or more characteristics of the movement are distorted when the virtual representation of movement caused by the user is displayed. The extent of the distortion is limited such that the distortion of the one or more characteristics is not perceived by the user. Thus, as the user views the virtual representation of the movement on the display, the user modifies the movement of the physical component based on a perception of the virtual representation by the user, due to the distortion of the one or more characteristics. Other details of the system relate to functions generally consistent with the steps of the method noted above.

This application specifically incorporates by reference the disclosures and drawings of the patent application identified above as a related application.

This Summary has been provided to introduce a few concepts in a simplified form that are further described in detail below in the Description. However, this Summary is not intended to identify key or essential features of the claimed subject matter, nor is it intended to be used as an aid in determining the scope of the claimed subject matter.

### DRAWINGS

Various aspects and attendant advantages of one or more exemplary embodiments and modifications thereto will become more readily appreciated as the same becomes better understood by reference to the following detailed description, when taken in conjunction with the accompanying drawings, wherein:

FIG. 1 is an isometric schematic view, wherein the left side of the Figure illustrates an exemplary embodiment of a six-degree of freedom Brake Actuated Manipulator (BAM), shown with Cartesian and spherical coordinate system orientations, and the right side of the Figure illustrates standing operation of the BAM with 2 m³ workspace sufficient for whole limb/body interactions;

FIG. 2 illustrates an exemplary screenshot of the experimental virtual environment in the phase between trials (when the subject was asked to answer perceptual questions involving the previous trial) and includes a cartoon of a subject performing a reaching motion from the upper right to lower left targets;

FIG. 3 (at plane A) is an exemplary schematic illustration of a screen of a computer monitoring a plane, depicting start and finish targets fixed in the subject's field of view, where a color of the final target changes from red to green and then to blue, to give the subject a sense of velocity feedback, and (at plane B), is an exemplary schematic illustration of the virtual environment with four stages of camera perspective displacements, shown while a subject traverses the path between the initial and final position, with the camera moving to the left, where each stage of traversal, parameterized by k, correlates to a shift in camera position and thus, a shift in the opposite direction of the world coordinate frame (the world coordinate frame is hidden from view during the experimentation);

FIG. 4A is an exemplary graph of the mean and standard error associated with the binary distributions gathered from perceptual data, wherein each line shows how frequently subjects were able to discern distortion at a particular level, and where the 50% level marks random guesses, and the 75% level is defined to be just noticeable;

FIG. 4B is an exemplary graph illustrating the resulting trajectories for the 45% level of distortion across all tested camera movement directions, wherein the manipulability ellipse for a planar 2-link arm is plotted along the average trajectories, and the ellipses for all trajectories are similar in the starting region of the motion;

FIG. 5 is an exemplary graph illustrating the shoulder and joint angles from the inverse kinematic model plotted for all of the final target positions across all distortion levels and camera movement directions;

FIG. 6 are graphs showing motion traces of a single subject exploring haptic disks of varying radii, both with and without a visual proxy, wherein it is apparent that no appreciable difference in motion is evident with the use of the visual proxy;

FIGS. 7A and 7B are respectively graphs showing outcome histograms for circularity and smoothness grouped by proxy condition and tabulating means and standard deviations, illustrating that the effect of proxy is significant in both cases (p<0.001);

FIG. 8 is an exemplary illustration of a peripheral drift illusion, where fixating on the center of any disk will eliminate the illusory motion in regard to that disk;

FIG. 9 illustrates the curveball illusion, where the left side of illustration shows a definition of the visual stimulus coordinate system, and the right side illustrates a motion trace of the object under motion and indicates that the internal luminance gradient modulates temporally, and that bulk stimulus motion proceeds in the negative y direction, where the overall perception of motion is shown as the dotted circle (it should be noted that the background color must have neutral contrast with respect to the internal luminance gradient, i.e., medium gray in this example, but is not depicted for clarity);

FIG. 10 is a graph illustrating the means of the perceptual velocity estimates over gross motion velocity subgroups for an illusory motion study, where conditions are broken out for frequency and angle, and both components of estimated illusory motion can be seen (the length of the error bars indicate two standard errors from the mean of the measured value—open circles);

FIG. 11 is a schematic illustration of a virtual environment within which the subjects compare compliances, and in which a spring, hidden from view, acts between an annular starting position and a goal line;

FIG. 12 are two graphs illustrating the results of the study of the perceived compliance of a virtual spring, wherein the top graph shows 11 comparison compliances and one reference value used for discrimination, and the bottom graph shows the stiffness of the corresponding compliance values;

FIG. 13 illustrates two graphs showing an interaction force with a virtual spring using force control, where the force is rendered with brake actuation in the graph on the left, and with a motor in the graph on the right;

FIG. 14 illustrates two graphs showing velocity profiles of two subjects over 100 trials with 10 levels of compliance, where the arrows indicate the direction of decreasing compliance, and the red line represents mean velocities from the median compliance group;

FIG. 15 illustrates four graphs showing psychometric curves for compliance perception across all experimental conditions, wherein dramatically different percepts are seen between the two types of actuators, the reference compliance is denoted by a vertical line, and two subjects (red lines) have lower haptic discriminatory thresholds than the other six;

FIG. 16 are graphs illustrating averaged psychometric functions from all subjects' data, where the vertical line indicates the reference compliance, the top graph illustrates the motor rendered comparison values, and the bottom graph illustrates the results when the brake is used to render the comparison compliance, showing that the presence of illusory stimuli has no significant effect on the perceptual curve;

FIG. 17 are two graphs illustrating values for the point of subjective equality (PSE) on the left and just noticeable difference (IND) on the right, across all conditions of the experiment, where error bars show the standard error of the mean;

FIG. 18 is a schematic diagram illustrating an example showing how the distorted virtual environment changes how a user visually perceives a modified characteristic of the motion caused by the user raising an object grasped in the right hand of the user;

FIG. 19 is an exemplary block diagram illustrating the control scheme for the robotic device in connection with the distorted virtual reality displayed to a user; and

FIG. 20 is a functional block diagram of a generally conventional computing device, such as a personal computer (PC), which is suitable for controlling a display and the BAM or other passive robotic device with which a subject is interacting while viewing a distorted virtual environment on the display, as described below.

### DESCRIPTION

### Figures and Disclosed Embodiments are not Limiting

Exemplary embodiments are illustrated in referenced Figures of the drawings. It is intended that the embodiments and Figures disclosed herein are to be considered illustrative rather than restrictive. No limitation on the scope of the technology and of the claims that follow is to be imputed to the examples shown in the drawings and discussed herein. Further, it should be understood that any feature of one embodiment disclosed herein can be combined with one or more features of any other embodiment that is disclosed, unless otherwise indicated.

### Introduction

Virtual reality possesses many desirable qualities that make it highly compatible for rehabilitation regimes. The breadth of techniques pertaining to rehabilitation in virtual environments is long and diverse. Much of the work focuses on the assessment of cognitive abilities, but recently, there has been a trend towards physical retraining of subjects. Virtual reality systems for training fall into two categories. The first category includes desktop setups using a robotic device and either a computer display screen or head-mounted display. The second category encompasses video or motion capture systems that can be paired with or without robotic interaction, and a suitable graphic display. The following discussion focuses on the first category, which is referred to here as the “virtual robotic environment.”

Robotic devices present rehabilitation opportunities for both the upper and lower extremities of subjects. When such devices are coupled with virtual reality, the combination provides features that are not provided by a human therapist alone, such as: real-time limb position and force measurement, fine control of repetitious movement, programmable stimuli, and, enabling a patient to work at home away from the clinic.

Large robotic devices have been built and used for rehabilitation paradigms in a lab setting (for example, MIME, WAM, Phantom 3.0, and HapticMaster). Currently, these devices contain active actuators that store energy and can move with unexpectedly high velocity or force during a failure mode. Safety is typically handled by software, or by limiting force/speed and range of motion (to deal with possibly hazardous situations). However, this process can make the haptic interaction too weak to be beneficial for whole arm and body therapies. To solve this problem, it is necessary to design a robotic device that is strong and fast, while remaining inherently safe in the event of a software or power failure, so that no injury occurs to the patient as a result.

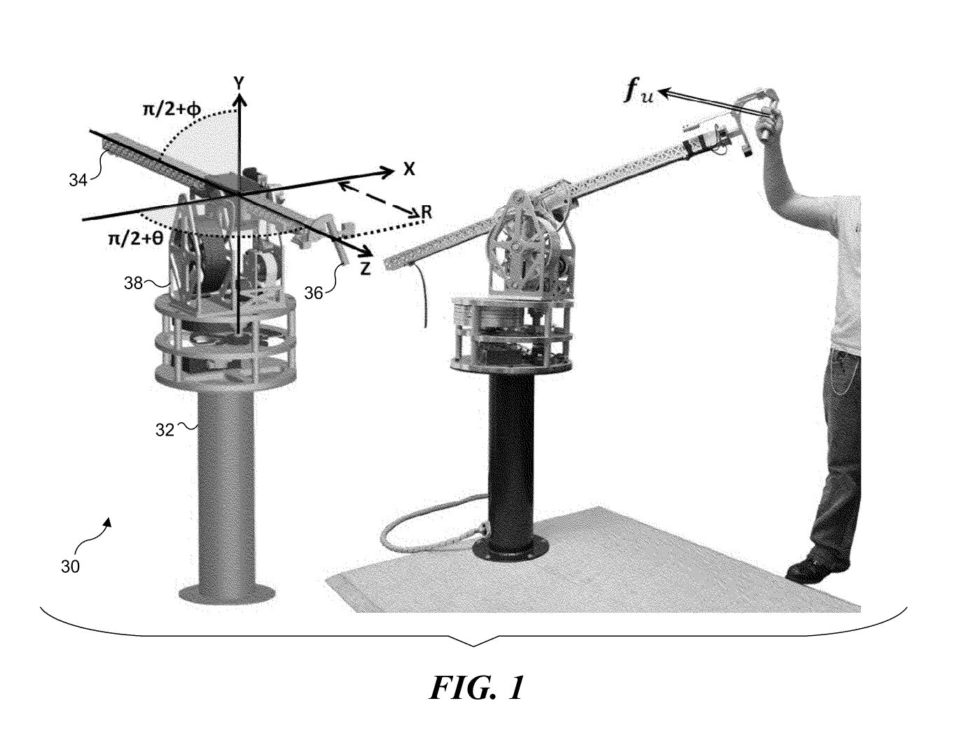

To alleviate these safety concerns, a passive actuation approach to system design was taken and is preferred in any machine or robotic device that interacts with humans in either work or domestic environments. A robotic device that uses a passive or brake actuated manipulation component cannot easily cause injury to a person that is interacting with it, while a motor actuated component can be improperly controlled and cause injury. FIG. 1 shows both a schematic diagram and a photograph of an exemplary six degrees-of-freedom (DOF) dissipative life-sized haptic device 30 referred to as the Brake Actuated Manipulator (BAM). This robotic device includes a base 32 that supports a clutch assembly 38 that can provide controlled resistance to a user moving an arm 34 in any of the six degrees-of-freedom, relative to the three orthogonal axes x, y, and z. The user grasps a handle 36 (as shown in the photograph) to move arm 34. Clutch assembly 38 applies a controlled amount of resistance to the motion provided by the user as arm 34 is moved and/or rotated relative to the orthogonal axes.

There are three types of passive devices: hybrid, steerable, and dissipative. Hybrid devices couple motors with dissipative elements to enhance stability. Steerable devices, e.g., collaborative robots (known as Cobots), use a continuously variable transmission to reorient their kinematic freedoms. Dissipative devices, like the BAM and a planar trajectory enhancing robot (P-TER) use either brakes or clutches to redirect energy and are inherently stable, enabling virtual constraints as stiff as the device's transmission enables. The inherent safety of dissipative devices affords much larger workspaces that permit whole body free motion interaction useful for sports medicine, rehabilitation, and large-scale object design applications. In the following discussion, the BAM was used in each of the studies reported. However, it must be emphasized that the BAM is simply an exemplary passive or dissipative device and is not intended to be in any way limiting on the concepts that are disclosed herein. It is expected that smaller and lower cost passive devices that do not require any motor to interact with a user will be developed when these concepts are commercially realized—both in the home and in the workplace. The intention is to provide a safe robotic device that uses brakes or clutches to vary forces experienced by the user without any concern of injury. Such device will include some form of position detection, whether potentiometers, optical sensors, or other form of encoder that provides the required resolution when monitoring the movement of a component of the robotic device when the user is interacting with the device. There are many applications for such passive devices in connection with the concepts discussed below.

While passive systems provide many advantages, the shift to braked actuation fundamentally changes common control strategies, and in some cases, limits important capabilities. For example, passive devices can only apply joint torques satisfying τᵢqᵢ≦0. Note that torque provided by a motor can satisfy either τᵢqᵢ≦0 or τᵢqᵢ>0, which results in challenges for providing arbitrary path constraints and rendering soft springs. Work has been done on path-following control with dissipative devices using both velocity and force control. However, performance is hampered by poor visual information when following complex three-dimensional paths, and these techniques cannot currently overcome the passivity constraints.

In order to provide an inherently safe virtual robotic environment with the ability to guide patients' limbs in any desired path, a method of creating movement to temporarily relax the passivity constraint was needed as a way to augment the passive device's lack of controllability. There are two ways this can be accomplished—either directly with the incorporation of energy storage elements into the mechanical subsystem, or indirectly by causing the operator to generate a response. The addition of springs or motors, creating a hybrid device, may enhance haptic effects, but decreases overall safety and increases device bulk, complexity, and power requirements. In light of this, an alternate solution was sought by manipulating the user's perception through visual feedback distortion to make the user self-steer their movement based on visual cues that differ from reality. This approach was a first attempt to alter a robot's ability to interact with humans using neuropsychological effects. By distorting a user's perception of reality, it is possible for a device that has only passive or dissipative actuation, such as the BAM, to appear to a user to have many of the same characteristics as a motorized device, but without creating the potential safety concerns arising from use of motors when the user interacts with the device.

The present approach illustrates the concept of visual feedback distortion as a means of controlling a user's limb trajectory without their awareness and beyond the actuation capability of the passive robotic device in use. An experiment was conducted that introduces visual feedback distortion, to observe how much a given motion path can be altered by the visual feedback distortion, as a basis for examining the ability to distort perception with respect to the body coordinates of the user.

### Experimental Method

An experiment was designed to test the effects of visual distortion on point-to-point reaching motions. The subject's perception of motion (distorted or not) was evaluated in the virtual environment with a defined discrimination task.

### Conditions

Experimental trials were randomized between direction (left, right, down) and the level of distortion that was applied (0%, 15%, 30%, and 45%), with ten trials for each condition. Each pairing of distortion level, direction, and trial number was given in a random order. Breaks were given every thirty trials to allow the subject a rest. During each reaching trial, hand position was measured in a Cartesian frame (FIG. 1) using angle and position encoders included on the BAM.

### Participants and Setup

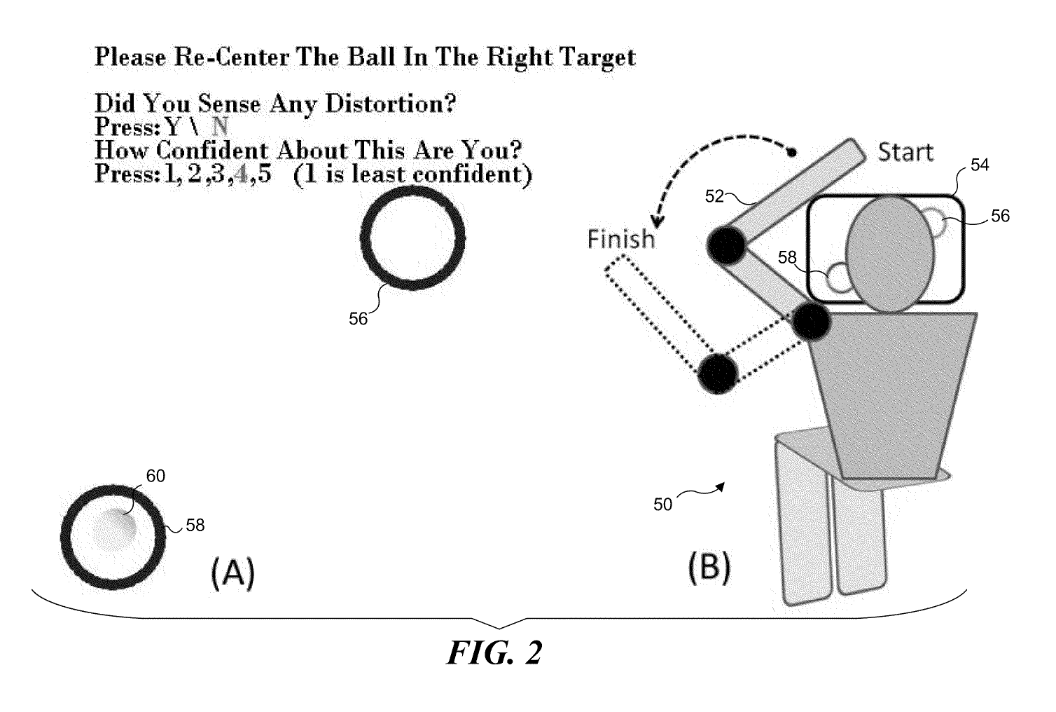

Four healthy subjects participated in this experiment. Each subject 50 sat in front of a computer screen 54 displaying the virtual environment, as illustrated on the right in FIG. 2. Subjects held onto the handle of the BAM with their left hand, and the specified path of the user provided by movement of the handle with a left arm 52 of the subject was over the left shoulder, starting over the head. Subjects were told not to look at their arm movement, but instead, to pay attention to the virtual environment displayed on computer screen 54. This path position was chosen so that subjects could not see their precise arm position, even though an occlusion panel or other device was not used to block the subject's view of arm 52. As shown on the left side of FIG. 2, each subject was allowed to sample the lateral movement of a ball 60 between a start position in a circle 56 disposed to the upper right of the display and an end target in a target circle 58 disposed on the lower right of the display, without any distortion, for as many times as they wished before the experiment started. The left side of FIG. 2 thus shows the visual feedback that the subjects received in the virtual environment presented on computer screen 54. The go signal was indicated by upper right circle 56 turning green. Target circle 58 (lower left) faded from red to green in 1.5 seconds then faded to blue in the next 1.5 seconds. Subjects were instructed to move ball 60 to the target circle by moving the handle of the BAM while target circle 58 was green. Between each trial, the subjects were asked a yes or no question to determine if they could sense any distortion (in relation to what the subject considered or perceived as “no distortion”), and then, to rate their confidence in this decision by selecting a value from one to five, with five being the most confident.

The data produced by this experiment enabled calculation of the frequency, over varying distortion levels, for which the subjects were able to correctly identify distortion. The confidence value “three” was selected as significant of a confident determination by a subject. The weighted responses from all subjects' perceptual data were compared against chance (50%), and the confidently noticeable distortion level (75%).

### Visual Feedback Distortion

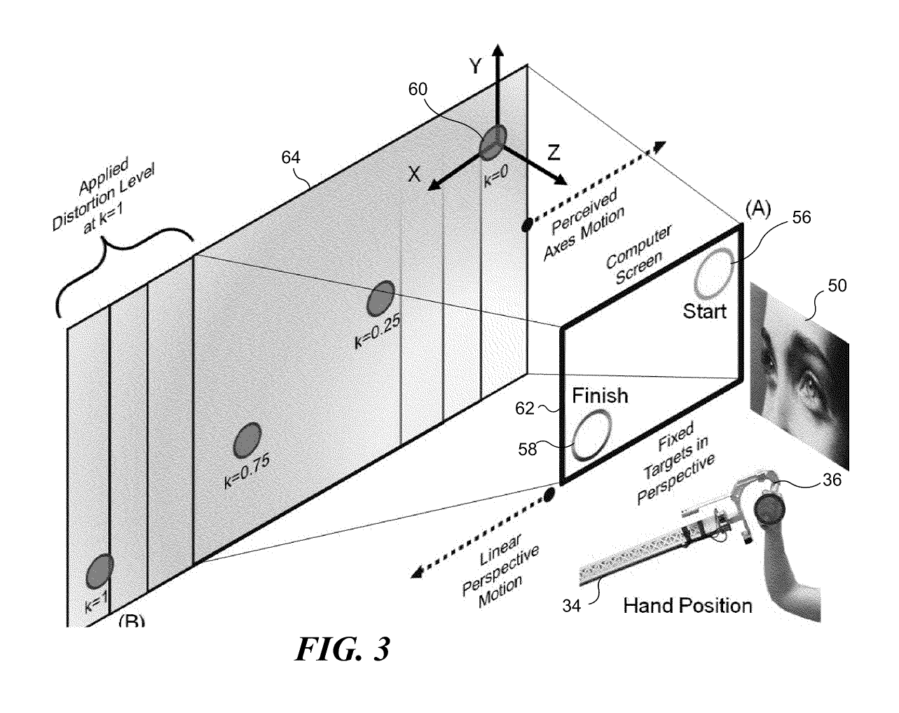

To provide the specified distortion conditions, the visual distortion (the difference between the actual and displayed movements) was created by moving the “camera” location where the virtual screen was shot. FIG. 3 shows how moving the “camera” while subject 50 performs the movement provides a graduated distortion as indicated on a panel 64.

As illustrated in FIG. 3, camera movement, or distortion, was linearly introduced with a single component of motion along one of three primary directions, left (positive x motion), right (negative x motion), or down (negative y motion), as the subject traversed the reaching motion as represented in the virtual environment by a ball 60 on computer screen 62 moving from circle 56 to target circle 58. Thus, the camera acted as if tethered by a 2-D spring to the fixed frame and forced by the user moving handle 36 and arm 34 of the BAM. The length of the path during the reaching motion, under zero distortion, was chosen to be 10 inches.

The coordinate position of the subject's hand is defined to be Tᵤ, and the subject's starting position, Tᵤ₀, is at the origin in circle 56. The final target circle position, Tₜ, is defined by the distortion levels in each direction, lₓ and l_{y}, along with the final target position with no distortion, Tₜ₀. The distortion levels, lₓ and l_{y}, are percentages of the undistorted path along the tested directional component of camera movement, as follows:

$$\begin{matrix}- 1 \leq {l}_{x , y} \leq 1 & ( 1 ) \\ {T}_{t 0} = [ \begin{matrix}- 10 \frac{\sqrt{2}}{2} & - 10 \frac{\sqrt{2}}{2}\end{matrix} ] & ( 2 ) \\ {T}_{t} = [ \begin{matrix}( 1 + {l}_{x} ) {T}_{t 0 , x} \\ ( 1 + {l}_{y} ) {T}_{t 0 , y}\end{matrix} ] . & ( 3 )\end{matrix}$$

The parameterization, k, of the path is found using (2) and (3), starting from the origin:

$$k = \{ \begin{matrix}0 , & \frac{‖ {T}_{u} ‖}{‖ {T}_{t} ‖} < 0 \\ 1 , & \frac{‖ {T}_{u} ‖}{‖ {T}_{t} ‖} \geq 0 \\ \frac{‖ {T}_{u} ‖}{‖ {T}_{t} ‖} , & \frac{‖ {T}_{u} ‖}{‖ {T}_{t} ‖} < 1.\end{matrix} \qquad ( 4 )$$

The instantaneous distortion magnitude is proportional to the distance traveled from the start location, reaching its maximum level at the final target position. The camera position, T_{c}, is calculated by multiplying the parameterization Eq. (4) by the distortion levels of Eq. (1) and the components of overall path length.

$${T}_{c} = k [ \begin{matrix}{l}_{x} \vert {T}_{t 0 , x} \vert \\ {l}_{y} \vert {T}_{t 0 , y} \vert\end{matrix} ] \qquad ( 5 )$$

With T_{c} defined in this way the camera slides along the distortion vector as the user traverses the path and ultimately reaches Tₜ. The initial and final targets appear fixed in the camera frame at the origin and Tₜ₀, respectively, and when k=1, the goal target circle has been reached at Tₜ, even though there was no visual (perceived) movement of the target.

### Results and Analyses

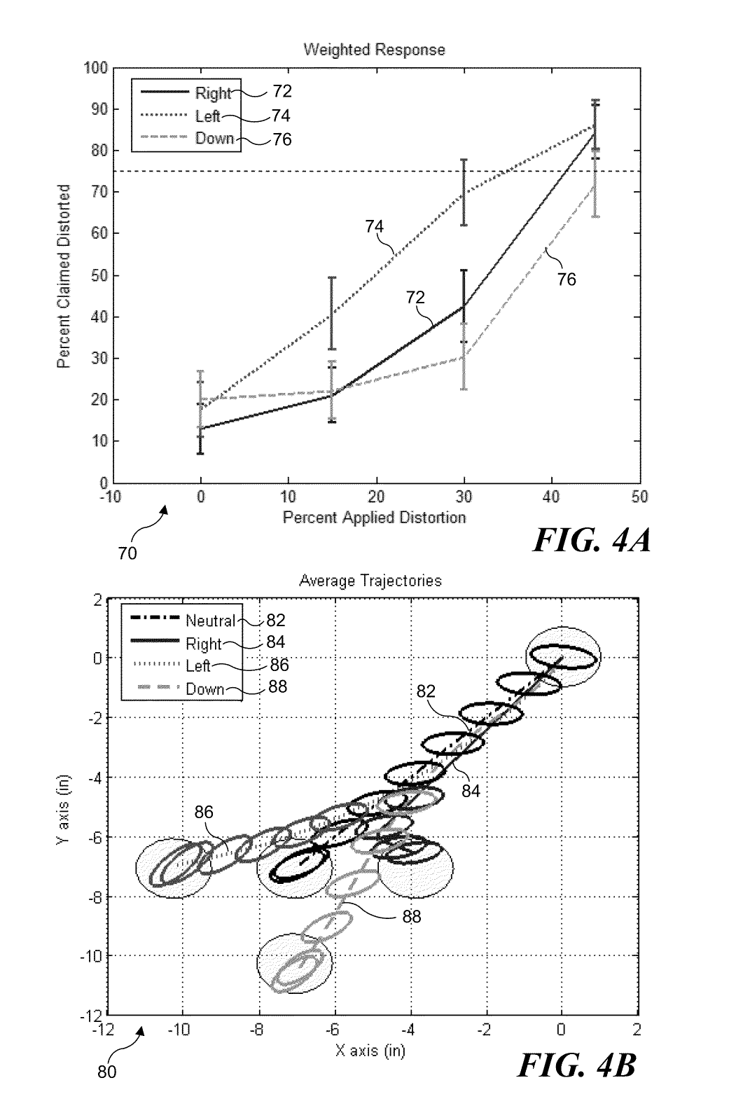

A graph 70 in FIG. 4A shows that distortion was unnoticed by the subjects up to the 15% distortion level for the left camera movement (a dotted line 74) and up to the 30% level, for both the right (a solid line 72) and down (a dash line 76) camera movements. These allowable distortion values are in agreement with similar measures calculated for pinching motions between the thumb and index finger.

A graph 80 in FIG. 4B shows that the trajectories with distortion are significantly different than the control (central target—neutral as indicated by a dash-dot line 82). In most cases, the subject smoothly transitioned to reach the target, but in one case, overshoot can be seen (right distortion as indicated by a solid line 84). The causes for this overshoot are chiefly due to timing constraints imposed by the experimental setup, coupled with the direction of distortion. When the camera moved to the right, the effect was to shorten the overall path length, thus increasing the velocity of the hand movement on the computer screen.

The distortion to the left (as indicated by a dotted line 86) was detected faster (p<0.05), while the weights for the other directions were statistically insignificant from one another. The distortion in the down direction is indicated by a dash line 88. In order to understand this difference between these three distortion directions, the movement's manipulability and the subjects' body mechanoreceptor sensitivities for the left distorted path were evaluated against the other two movements.

A manipulability ellipse indicates in which directions motion or force are easily permitted. Consider the set of all end effector velocities, v, which are realizable by joint velocities, \dot{q} such that \dot{q}<1. This set is an ellipsoid that describes the manipulability of a linkage by both size and orientation. The Euclidean norm of \dot{q} can be written as:

∥\dot{q}=\dot{q}^{T}\dot{q} (6)

And through the Jacobian relationship, v=J\dot{q}, it can be shown that Eq. (6) is equal to,

\dot{q}^{T}\dot{q}=v^{T}J⁻¹^{^{T}}J⁻¹v (7)

The quantity J⁻¹^{^{T}}J⁻¹ gives the matrix that defines the ellipsoid. The axes of the ellipsoid are defined by its eigenvectors, and their magnitudes are equal to the eigenvalues of J⁻¹^{^{T}}J⁻¹. A similar method is used to find the force ellipsoid, which has the form of:

τ^{T}τ=f^{T}JJ^{T}f (8)

These ellipsoids depend heavily on the Jacobian, and hence, on posture. A 2-link serial robot was used as a model, with the link lengths l₁=10 inches and l₂=13 inches, and a shoulder centered at (3, −13) inches.

Along the major axis of the manipulability ellipse, large movements can be made, and motion along the minor ellipse axis is more difficult. If the difference in a subject's ability to detect distortion is related to manipulability, then a relationship should be found between the manipulability ellipse's angle and the subject's ability to detect distortion. FIG. 4B shows the resulting trajectories for the 45% distortion level with manipulability ellipses. The result indicates that distortion to the left should be difficult to detect, since the motion is aligned along the major axis of the ellipse, showing that the manipulability ellipse is a poor estimator of distortable directions.

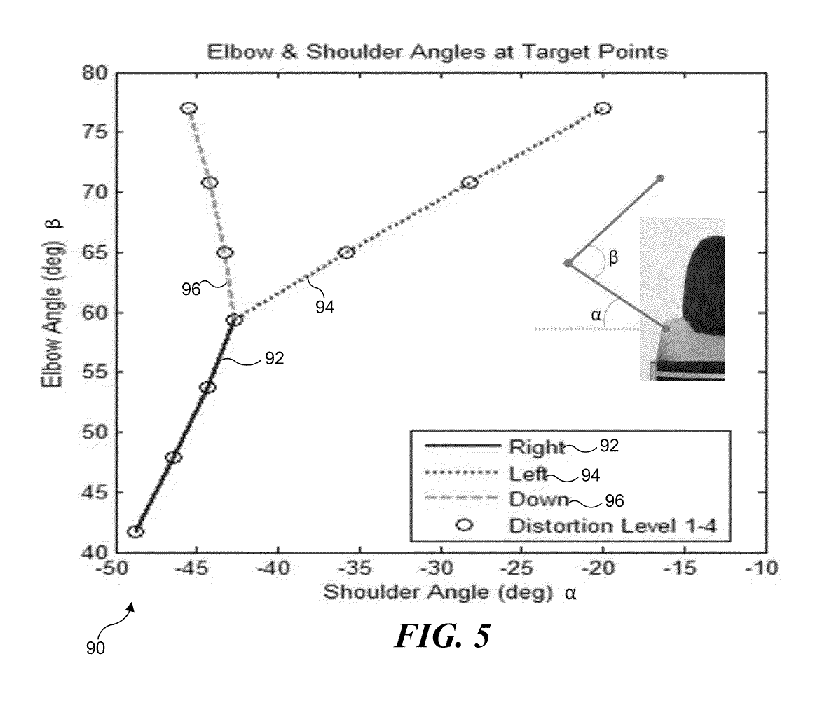

To investigate this issue further, attention was given to the mechanoreceptor sensitivity in the elbow and shoulder. It is known that joints proximal to the body give a subject a better perception of their angle than those that are distal. The shoulder is reported to be approximately three times more sensitive to position than the elbow. This difference in sensitivity can be understood by realizing that the central nervous system must perform a coordinate system transformation between a person's hand position and joint angles. Thus, the farther away from the body a joint resides, the larger will be the error incurred through this process. Looking at the joint angles from the inverse kinematic model of a 2-link arm for each target position across all levels of distortion gives an idea of the proportion of motion associated with each joint away from the zero-distortion target, as shown by a graph 90 in FIG. 5. The inverse kinematics for the 2-link arm (FIG. 5) are found using the law of cosines and similar geometric principles:

l₃²=(T_{u,x}−T_{s,x})²+(T_{u,y}−T_{s,y})² (9)

β=cos⁻¹(l₃²−l₂²−l₁²/=2l₁l₂) (10)

γ=sin⁻¹(l₂ sin β/l₃) (11)

ε=α tan 2(T_{u,y}−T_{s,y},T_{u,x}−T_{s,x}) (12)

α=π=γ−ε (13)

where α is the shoulder angle relative to the horizontal, and β is the inner angle at the elbow. Although this is a non-canonical formulation for the joint angles, α and β, it provides an intuitive relationship for quick physiological comparison as seen in FIG. 5.

All three directions of camera motion incurred similar amounts of elbow motion, as indicated in FIG. 5 by a solid line 92 for movement to the right, a dotted line 94 for movement to the left, and a dash line 96 for movement down, while only distortion to the left created a large shoulder displacement. Since the shoulder is more proximal to the body than the elbow, it affords a subject a higher precision, thus resulting in quicker detection of visual distortion.

Conclusion Drawn from this Experiment

It has been shown that visual feedback distortion in the virtual environment can be used as a way to “actively” move a subject's arm in a different manner from the intended movement without their awareness. This manipulation is conditioned upon the subject's posture as evidenced by the inverse kinematic analysis. Although the visual feedback distortion presented here is simple, it provides a foundation on which to improve on the controllability of passive devices for virtual robotic environment.

### Effect of Visual Distortion on Perception of Haptic Geometry

As shown above, a visual dislocation, or distortion, between a user's hand and their avatar can be purposefully introduced to affect arm motion. The visual distortion introduced by a single degree of freedom controller with a visual proxy will now be considered.

Single degree of freedom control creates a discrepancy between what is seen visually, and what is felt kinesthetically through a haptic display. Without visual augmentation, the user's avatar is seen to penetrate a graphical representation of a haptic object, as it remains true to its coherency with the end effector. Often, this penetration is dramatic, because the kinematics chosen by the single degree of freedom controller are traced out. Introducing a proxy for the avatar creates a scenario in which there is visual distortion between visual and proprioceptive senses, and this conflict can alter haptic perception.

It has been shown that a visual discrepancy, or avatar proxy, can influence the perception of force direction. If a visual proxy is used for a user's avatar, which is constrained to the surface of the geometry, it may be possible to enhance the haptic perception of the object beyond the haptic display's approximation without complex control methodology or mechanical design. To test this theory, an experiment was conducted.

### Methods

Of interest is the effect of visual distortion through proxy of a user's avatar. For the virtual environment, a single degree of freedom control with a penalty based method was tested for force response. The chosen haptic geometry is a planar disk disposed in the X-Z plane and centered in the device's workspace. The BAM is constrained to the disk's plane by saturating the pitch axis' brake and allowing interaction only with the yaw and prismatic axes. The stiffness chosen for the penalty-based forced response is 1.75 N/mm (10 lb/in).

To provide an immersive wide field of view, a piSight™ head-mounted display (HMD) was used for viewing the planar haptic disk. In addition, a dark shroud covered the HMD, blocking ambient light and occluding the subject's upper extremities from view. This occlusion is crucial, because this approach plays upon the discrepancy between the user's hand and the perceived hand location in the virtual environment to affect perception of the planar disk.

In this study eight healthy (unimpaired) subjects participated, and all had normal or corrected-to-normal vision. Each subject was instructed in the use of the BAM and the HMD. They were allowed to calibrate the HMD so that no seams were apparent through the HMD's tiled optics. After calibration, each subject was given the instruction to explore the surface of the disk, which was visible to them through the HMD. They were told that their hand has an avatar in the virtual world, and then shown it's correspondence to their hand's motion, without interaction with the haptic disk. After this period of acquaintance, the subjects were signaled to begin exploring the object, and when satisfied about the object's characteristics, to return their avatar to a waiting area, after which the trial ended.

### Conditions

Two parameters were varied, including the disk radius (a continuous variable), and the presence of a visual proxy (a categorical variable). After each trial, the subject was asked to respond to two questions about the haptic properties of the object they just felt. The properties in question are the smoothness and degree of circularity of the object. No specific criteria were given about smoothness, and for circularity, the participants were told to judge based on how circular the object was perceived to be. The responses were given on a scale from one to ten, with ten representing the ideal characteristic. Five disk radii were tested to determine the dependence and effectiveness, if any, of visual distortion through proxy on the perceived smoothness and circularity of the disk, for a total of ten trials. The radii tested, rᵢ ε r₁ . . . r₅, are 254 mm (10 in), 203.2 mm (8 in), 152.4 mm (6 in), 101.6 mm (4 in), and 50.8 mm (2 in).

General linear models in Minitab™ Statistical Software (Minitab Inc., State College, Pa.) were used to assess the effects (p≦0.05) of disk radius, participant, and visual proxy on smoothness and circularity, with post-hoc two-sided Tukey's Simultaneous tests.

### Visual Proxy

For geometrically complex objects, the proxy location can be found through the god object method, and because of the simplicity of the chosen haptic geometry, i.e., a disk, the location of the visual proxy is easily determined. Given the disk's center in Cartesian space, \vec{P}, the location of the user's hand, \vec{X}, and assuming both the disk and user's hand lie in the same plane, the proxy location, \vec{P}′, during collision is found to be:

$${\vec{P}}^{′} = \vec{P} + \frac{\vec{X} - \vec{P}}{‖ \vec{X} - \vec{P} ‖} {r}_{i} \qquad ( 14 )$$

It can be assumed that the user's hand and the disk lie in the same plane because the BAM is set to constrain motion out of this plane by saturating its pitch axis' brake. The user's hand was only proxied for half of the trials; the other half were completed with the avatar shown in the coherent location given by \vec{X}.

### Results

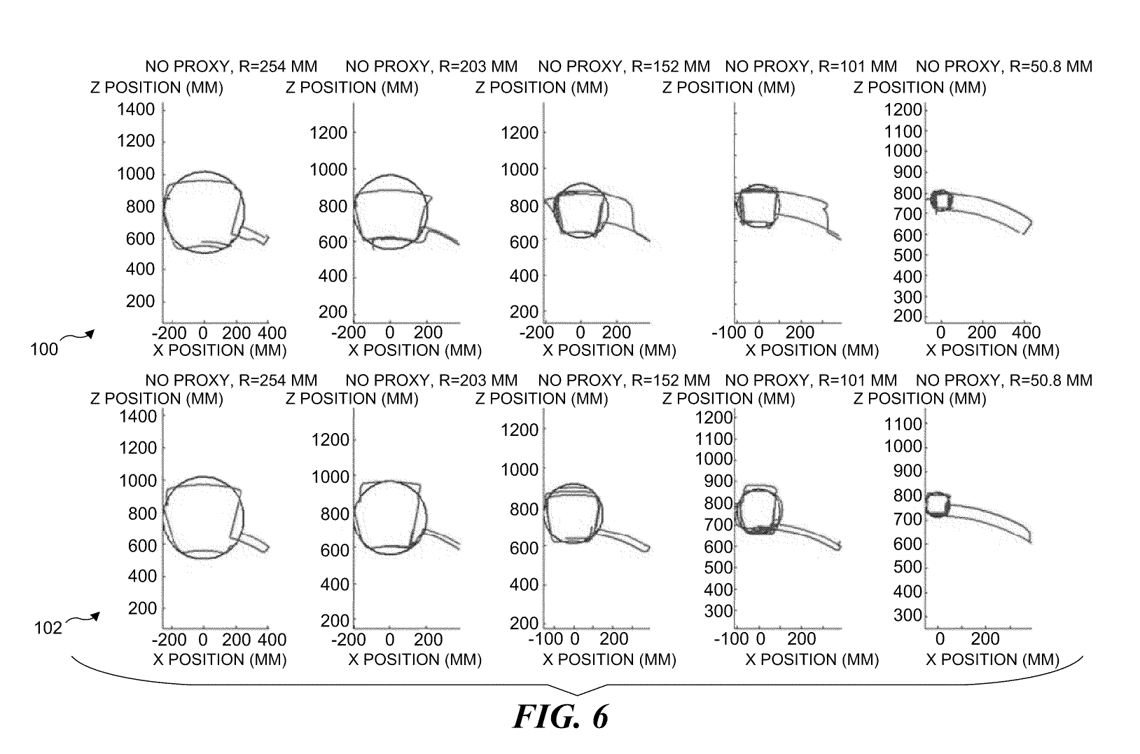

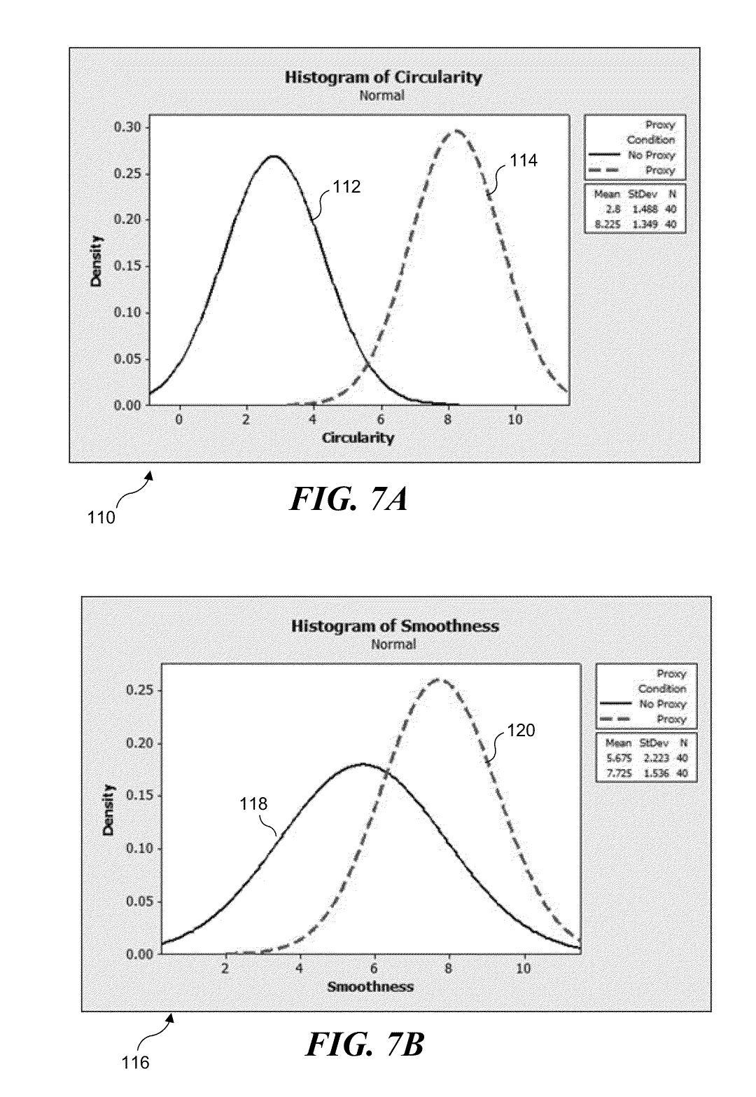

A single participant's motion traces for conditions both with (in a graph 100) and without (in a graph 102) visual proxy across all disk radii is shown in FIG. 6. A three factor ANOVA showed statistically significant effects (p<0.001) for the presence of a visual proxy on both smoothness and circularity. Disk radius and the identity of the participant had no significant effects, p>0.3 and p>0.1 respectively, on the outcomes. A histogram was fit to the data for both outcomes, the distributions for circularity in a graph 110, and smoothness in a graph 116 can be seen respectively, in FIGS. 7A and 7B. In graph 110, no proxy is indicated by a solid line 112, and proxy by a dash line 114, while in graph 116, no proxy is indicated by a solid line 118, and proxy by a dash line 120.

### Discussion & Implications

The results of this study are dramatic; there is a large difference in perception of circularity with just the simple addition of a visual proxy, as evidenced by the difference in the mean of the histograms for proxy and no proxy in FIG. 7A. In addition, the subjects perceived much smoother surfaces from the haptic geometry, even though the rendering algorithm remained the same between the two conditions. Subjects chose higher values for smoothness on average, with lower overall variance when the visual proxy was present, as can be seen in FIG. 7B. This effect from visual distortion shows how overwhelming the gestalt of visual capture can be in a virtual environment, dramatically different percepts occur based solely on visual input.

A key factor in the success of this study is the use of an occlusion device or shroud to hide the subject's upper extremities. This shroud weakens a subject's sense of proprioception, and the subject can no longer estimate their hand location visually. At the same time, the shroud forces the subjects to rely on the visual information provided about their body's orientation through the HMD. Without knowing the visual information is non-veridical, sensory conflict occurs, and perception is altered. Each subject literally had the “wool drawn over their eyes.” It is also interesting to consider the radius of curvature of the haptic geometry versus the curvature of the kinematics to which the single degree of freedom controller is constrained. Because the haptic disk spans a section of the BAM's workspace, the instantaneous curvature that the controller can choose to approximate the surface may vary depending on the user's position within the workspace.

As an approximation of the instantaneous curvature chosen by the controller, the average defined by the radius of curvature given by the center of the haptic disk can be examined; this value is ˜1.312 m⁻¹. This average curvature is what the user actually feels in approximation of the disk's actual curvature.

Taking the ratio between the curvature of all the disks and the average curvature yields a value that represents the difference in visually simulated versus haptically experienced curvatures. For the five disks used, this ratio is between 3 and 15, which implies that the largest disk has the closest curvature to a subject's kinematic approximation, and the smallest disk has a curvature 15 times that of the kinematic approximation.

One would assume that an increasing mismatch between the object curvature and kinematic curvature of the device would lead to a decreased perceptual effect. However, this result is not found. The statistical analysis showed no significant effects of disk radius on the perceived smoothness or circularity. Therefore, it can be concluded that the visual proxy also affected the perception of curvature in the virtual environment, because the smallest disk, with highest curvature and arguably the most obviously not circular, was in fact, thought to be a small circular disk. One subject said, “It was like the difference between night and day,” when commenting on the different percepts with and without a visual proxy.

From FIG. 6, it can be seen that there are no significant changes in the participant's behavior when haptically exploring the object with a visual proxy. The path traversed by the subject's hand was almost identical with or without a visual proxy. Therefore, the difference in perception can almost entirely be attributed to the interpretation of visual stimuli.

The implication of this effect from visual distortion carries weight for passively actuated devices, which are inherently limited by their mechanics as to which directions smooth surfaces may be displayed. It seems the use of a visual proxy allows object curvature to be approximated, to a fairly significant degree (15 times), which not only enhances the realism of haptic objects, but can relax design complexity of future passively actuated devices. Based on these findings, it is apparent that passively actuated devices should always employ a visual proxy when using single degree of freedom control to render objects.

### Effect of Visual Illusion on Perceived Motion of Virtual Objects

Researchers in the field of pseudo-haptics typically examine perceptual illusions, which are designed to trick the haptic sense using haptic analogues of visual illusions or methods of visual distortion that dislocate the virtual avatar from the real hand position. One study alters the perceived mass of a virtual sphere by manipulating the control/display (C/D) ratio. The C/D ratio effectively represents a gain between hand motion and avatar motion. With a low C/D ratio, the apparent mass seems to increase, as has been shown using a discrimination task. Using a similar method of visual distortion, a virtual hand is displaced relative to an actual hand location with an augmented reality system, and the researchers instruct the subject to keep their virtual hand inside a visual force field created by fluid flow. The resulting dislocation creates a feeling of the user's hand being pushed as they mitigate their avatar's movement, despite no actual force feedback being applied. Other studies have examined the perception of stiffness as experienced through an isometric device, or with visual distortion where the visual motion of the spring differed from the stiffness of the haptic object. There is an excellent discussion in the literature dealing with haptic illusions and pseudo-haptics, which describes the above studies in greater detail. A common thread through the literature shows how dominant a human's visual system is, and the effectiveness of visual capture for altering our perception in virtual environments.

It would seem that researchers of pseudo-haptics have singularly investigated the type of visual distortion that creates dislocation, and thus, sensory conflict, for use in virtual environments. One potential issue with this strategy is the eventual wandering of the user's physical location. Only so much visual distortion can be accumulated along a path before the user has physically left the workspace and needs to re-center themselves.

There is another class of illusions that induces perceptual effects without direct dislocation of the avatar and physical hand. This class of illusions creates perceived self-motion or generates its own illusory motion in the scene. Two illusory phenomena related to this are apparent edge-motion from the luminance relationship between visual elements, and vection (both linear and angular).

### Perceived Illusory Self-Motion—Vection

When a stationary observer is exposed to a large visual scene that moves uniformly, a sensation of self-movement in the opposite direction from that of the scene is induced. This phenomenon is known as vection and is explained by the fact that vestibular and visual inputs converge in the nervous system. When an observer is moved at a constant velocity, the sensation of self-motion is maintained mostly by visual input and optic flow because the vestibular system responds only to self-acceleration. It follows that movement of large scenes is the natural cue for constant self-movement. Thus, when visual motion of a large scene is presented in the absence of body motion, the sensation of self-motion in the opposite direction may be induced.

Prior art experiments on humans with both linear and circular vection have analyzed the perceived amount of self-motion with stimulus velocity, the effects of stimulus size and position with and without points of fixation, and the presence of illusory self tilt. In the case of measuring illusory self tilt, a rotatable virtual room filled with household objects, the “tumbling room,” was used to indicate gravimetric cues to the subjects. Typically, these types of experiments take place in a large rotating drum with textured walls rotating at various speeds while the subject is either standing, sitting, or supine. Findings on human subjects have shown that a stimulus presented with fixation points facilitated vection, and often, that objects near fixation points seemed to lag or lead objects in the periphery, as with the tumbling room. Illusory self-tilt was limited to 20°, most likely by the gravireceptors in the brain indicating a subject is erect, but 360° self-rotation was observed for rotation about the spinal axis. Vection was also shown to influence posture and direction of locomotion.

Although there is great potential for the use of vection in immersive virtual environments to enhance the realism and create a feeling of motion, i.e., riding in a car or on a roller-coaster, the effects seem to be centralized on posture and whole body motion. Thus, their utility is specialized, because the perceived self-motion has not been reported to be localizable to individual body parts due to its effect on the vestibular sense. Accordingly, this discussion is not directed to a different phenomena that creates illusory motion within its visual context.

Illusory Motion from Luminance Relationship of Visual Elements

The human eye is a remarkable piece of biological hardware and is known as the window to the soul, giving us the ability to analyze, discriminate, and perceive our environment with a clarity unmatched by our other senses. The eye, however, is not without its quirks. Humans have natural blind spots where the optic nerve passes through the retina and visual acuity is non-constant, varying over the field of view. Foveal viewing of objects, within the center 5-10° of a single eye's field of view, is where the highest visual acuity occurs and ganglion nerves have a near 1:1 ratio with light sensing cells. Outside of the foveal region (peripheral) of the retina, the density of ganglion neurons drops dramatically, and multiple rods can be tied to a single ganglion in this region, which acts as an integrator/amplifier for groups of rods. The bundle of ganglion nerves from the entire retina forms the optic nerve that eventually descends into the visual cortex through the optic radiations, which cross into the temporal lobe.

Light sensing elements in the eye are located on the retina, and there are two varieties—rods and cones. The cones sense color information based on the wavelength of incident photons, while the rods sense luminance values and are responsible for our ability to see in low light conditions. Cones are highly dense near the fovea, while rods are denser towards the periphery. The rods are much more sensitive to light than cones and can be activated by a single photon, whereas cones require more than 100 photons to become activated. For this reason, people can easily detect movement out of the corner of their eye.

### Luminance—not Just Grayscale!

Luminance is the perceived lightness of color, which is different from brightness, lightness, intensity, etc. There are many ways of defining color spaces, including red-green-blue (RGB), hue-saturation-lightness (HSL), hue-saturation-value (HSV), CIELAB, and others. The color gamut of RGB is a linear space and can be arranged on a cube. HSL and HSV are transformations of RGB into a cylindrical space, and since they are transformations of RGB, they do not directly contain information about luminance. Linear color spaces are popular because they are computationally efficient, although lacking in perceptual relevance to assist in choosing a color.

For example the luminance of pure green is 0.87; pure red has a luminance of 0.5; and, pure blue has a luminance of only 0.29. White and black have a luminance of 1.0 and 0.0, respectively. The relatively high luminance of green light is why green laser pointers appear so much brighter than red ones, i.e., because green corresponds with the highest spectral sensitivity of the human eye. For colors, the mapping to luminance is non-linear. For a gray scale image, the luminance is proportional to the shade of gray. The CIELAB color space aspires to be a perceptually uniform color space, approximating natural human vision, based on the eye's spectral response, and can be used to find the luminance of a given color.

Because the rods are highly sensitive to luminance in visual imagery, and because the highest density of rods lie in a region where visual acuity is low (i.e., in the peripheral field), the eye is subject to illusory peculiarities involving luminance.

### Peripheral Drift Illusions

Peripheral drift illusion refers to an illusory motion generated by the presentation of a variable luminance profile in the visual periphery, in connection with static imagery. It has been proposed that there are three prerequisite conditions for eliciting the illusion.

1. There must be a “resetting” process, by which transients are generated in the visual system through either blinking, eye movement, or a moving stimulus.

2. The luminance gradient determines the direction of perceived motion from low to high intensity.

3. The stimulus must be viewed eccentrically, or with peripheral vision, because information is integrated over large areas of the retina in the periphery.

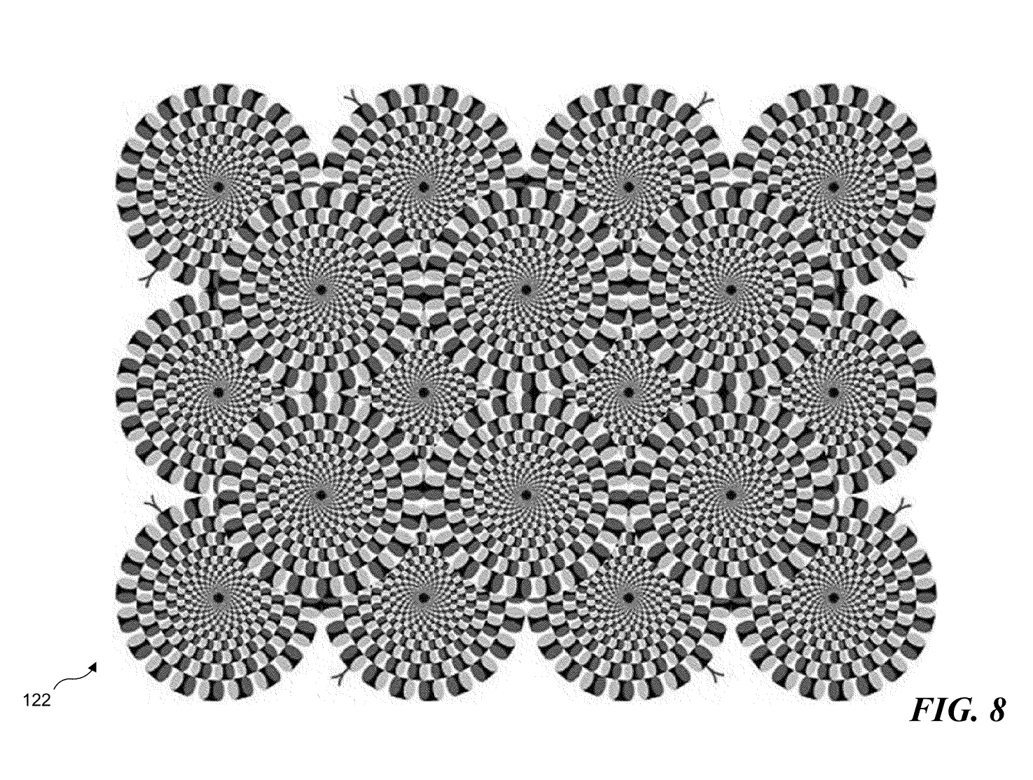

Point number one is self-evident from the viewing of such stimulus. Point number two results from luminance intensities traveling through the visual system at different speeds, i.e., lighter is faster, darker is slower. Point number three accounts for two separate layers of visual information integration, a first layer that directly integrates luminance information, and a second layer that integrates the first layer's information into a spatio-temporal perception of motion. Accordingly, other researchers refer to this concept as the “peripheral-spatiotemporal-integration hypothesis.” Initially, when a luminance gradient is seen, the first layer of integration receives a larger amount of high intensity signal, and when this signal is integrated across a wide area, the spatio-temporal integrator perceives a net motion in the direction of high intensity luminosity. This effect washes out after the initial transient, which indicates the need for a visual refresh or reset to trigger the illusion once again. A variant of the initial visual stimuli is described in the prior art and is reproduced in FIG. 8; the illusory motion is quite strong, unless vision is fixated on a certain point. When an image 122 shown in FIG. 8 is viewed in color, the disks comprising the image appear to spin about their centers. This image should be observed while generally looking at the center of the image or reading adjacent text, to trigger the illusion. However, in grayscale, the illusion of spinning disks is not very evident. The neural mechanisms of this illusion have been investigated in the prior art literature, and it was found that direction-selective neurons in the macaque visual cortex give directional responses to luminance gradients in a direction in agreement with the direction of the illusory motion, which is consistent with the above prior art hypothesis.

Another type of peripheral drift illusion is based on edge and center modulation of luminance values, which refers to a stimulus configuration in which there is a single temporally modulated field and multiple sources of contrast information. The sources of contrast information are then set to modulate at different temporal frequencies or with different phase from each other. For example, imagine a square with a thin border. If the luminance of the inner portion of the square is fixed and the border varies its luminance sinusoidally, the overall perception is of the square alternately shrinking and growing. A variant of this illusion breaks the thin border into four individual thin lines. If opposing lines of the border are shaded with a sinusoidally varying luminance, and the other pair of border lines are given the same sinusoid, but phase shifted 90°, then the perception is of a square alternately shrinking and growing along its principle axes; seemingly to demonstrate both strain and necking of a sinusoidally tensed/compressed square.

Recently a new variant of peripheral drift illusion has emerged which combines two types of motion, viewed peripherally, with a dependence on the contrast between interior luminance of the stimuli and luminance of the stimulus' background. For this illusion there is a moving luminance gradient (similar to a barber pole) inside of an object which has a bulk motion, thus two sources of motion information. A person's visual system is forced to make a choice when interpreting these motions through peripheral vision. This illusion, referred to as the “curveball” illusion has been demonstrated by the Shapiro Lab at Bucknell University. There has not yet been a publication on the topic except for a submission to the Best Illusion of the Year Contest in 2009, sponsored by Scientific American, which the curveball illusion won.

If the curveball illusion is viewed foveally, the visual system is able to distinguish the two types of motion. However, when viewed peripherally, the peripheral vision system, which works differently (lower acuity & high degree of integration of information), seems to blur the motions together and the internal motion of the luminance gradient dominates. This property is termed feature blur, the hypothesis being that the machinery of the foveal system allows us to determine individual motion sources, whereas in the peripheral field, this machinery is absent. The cumulative effect of the illusion is to generate constant perceived motion in the direction of the moving luminance gradient on top of the bulk stimulus motion. The effect is quite profound and startling.

This illusion also juxtaposes motion over different scales. When the background behind the stimulus is gray (luminance of 0.5) the short range motion signal from the internal motion of the luminance gradient is stronger. If there is high contrast between the background and the stimulus the long range bulk motion of the stimulus dominates. Thus, careful control over the background luminance is imperative.

### Perceived Motion Hypothesis

Although created by vision scientists and psychophysicists for their intriguing effects and ability to ascertain the peculiarities and internal workings of the perceptual system, these peripheral drift illusions have not been examined for their potential use in virtual reality.

Peripheral drift illusions are interesting because they are in and of themselves energetic; they create perceived motion from optical flow, luminance gradients, and visual stimulation. It may be possible to utilize this energetic behavior to compensate for the lack of it in passively actuated devices, such as the BAM. Before these types of illusions can be harnessed for useful control laws, their properties must be understood, and modeled if possible.

The characterization and perceptual modeling of the curveball illusion can serve as a way to generate perceived motion of a user's avatar in a virtual environment without introducing visual distortion or dislocation between the user's hand. Momentum is a natural way to express change in motion, given information about an object's velocity. Therefore, it can be hypothesized that the perceived motion is related to a “visual momentum” of each visual characteristic of the stimulus. Thus, the perceived motion from the curveball illusion could be predicted through a linear combination of the visual momentum associated with the stimulus' bulk and interior motion. For this analysis only planar motion is considered. Following the physically-based analogy, an inelastic collision where momentum is conserved, but two objects stick together, can be described by:

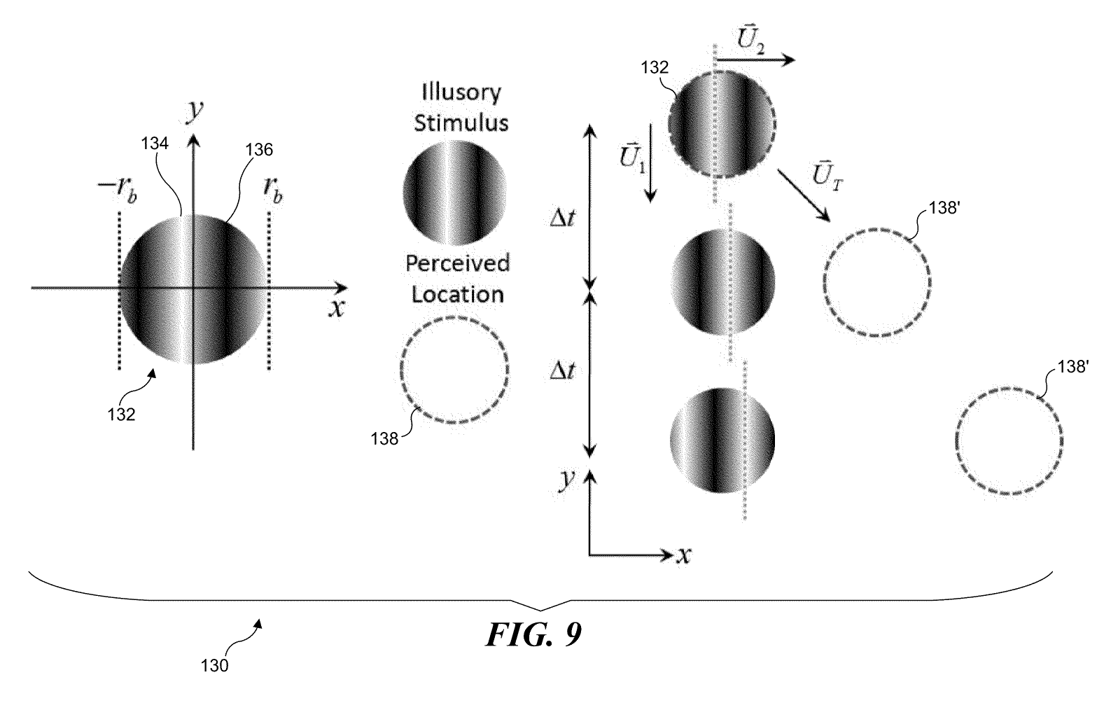

m₁\vec{U}₁+m₂\vec{U}₂=(m₁+m₂) \vec{U}_{T} (15)

where m₁ and m₂ are the “visual mass” of the object's motion, \vec{U}₁ and \vec{U}₂ represent the velocity of the individual visual elements, and \vec{U}_{T} is the total perceived visual motion of the entire stimulus. These quantities and a pictorial representation of the curveball illusion can be seen in details 130 of the illusion and the grayscale coloring of a spinning ball 132 shown in FIG. 9. The masses are effective weights on the velocity of the visual elements, and as such, this result is essentially a linear combination.

The bulk motion of the stimulus, \vec{U}₁ is known a priori because it can be directly set; however, the motion from modulating the internal luminance gradient must be analytically determined.

The appearance of the stimulus is defined using the OpenGL interface to the graphics card by rendering a sphere of radius r_{b} and then using the graphic processing unit's (GPU's) vertex shader to individually color the vertices of the sphere according to a temporally varying sinusoid, varying the luminance gradient from a light band 134 to a dark band 136. When the sphere is observed foveally, the sphere is seen to fall vertically, as indicated by a dotted circle 138. However, when the sphere is observed using peripheral vision, the illusion becomes evident as the sphere appears to be moving down and to the right, as indicated by dotted circles 138′ and 138″. The sphere's internal coordinates, before transformation into world coordinates, are centered at the origin, and the color of a single vertex along the abscissa is defined by:

$$C ( x , t ) = \frac{1}{2} cos ( \frac{2 π t}{T} - \frac{N π}{2} ( \frac{x}{{r}_{b}} + 1 ) ) + \frac{1}{2} \qquad ( 16 )$$

where T is the period of the sinusoidal motion, x is the location of the vertex to be colored, N is the number of periods (or stripes) to display within the sphere, and t is time. The sinusoidal motion is scaled to fit the range of luminance intensities (0,1). Because the color of a particular vertex at location x is invariantly related to the phase, and color at each vertex shifts in time, the effect is to circulate the luminance gradient over the surface of the sphere along the x axis. This circulation, or modulation, of the luminance gradient can be seen in FIG. 9, and the location of a constant luminance value is tracked by the dotted vertical line on the right side of the Figure.

To find the velocity of a line of constant luminance across the sphere, Eq. (16) is rearranged so that x=f (C,t). In this case C becomes a constant because the interest is in tracking a constant luminance value,

$$x = {r}_{b} ( ( \frac{2 π t}{T} - {cos}^{- 1} ( 2 C - 1 ) ) \frac{2}{N π} - 1 ) . \qquad ( 17 )$$

Taking the derivative of Eq. (17) yields,

$$‖ {\vec{U}}_{2} ‖ = \frac{4 {r}_{b}}{NT} \qquad ( 18 )$$

Eq. (18) is valid for luminance modulation with a constant frequency. The discussion below will consider the effects of varying this frequency with time. If the direction of luminance modulation with respect to the x-axis, shown in FIG. 9, is set by an angle θₗ, then Eq. (15) can be re-written as,

$${\hat{n}}_{l} = [ \begin{matrix}cos {θ}_{l} \\ sin {θ}_{l}\end{matrix} ] \\ {\vec{U}}_{T} = \frac{{m}_{1} {\vec{U}}_{1} + \frac{{m}_{2} 4 {r}_{b}}{NT} {\hat{n}}_{l}}{{m}_{1} + {m}_{2}} \qquad ( 19 )$$

It is useful to assign matrix properties to the visual mass terms, and this step has the benefit of describing an individual's tendency to weight the illusory motion differently in each cardinal direction. It is assumed that normal behavior for weighting bulk motion is identical in the cardinal directions. Thus, the mass matrix for the illusory term is a transformation of the bulk's visual mass. Adding off-diagonal elements to either mass matrix increases model flexibility for describing unexpected phenomena. The matrix definition of Eq. (19) is stated as follows

$${M}_{1} = [ \begin{matrix}1 & 0 \\ 0 & 1\end{matrix} ] = 1 \\ {M}_{2} = [ \begin{matrix}{γ}_{x} & 0 \\ 0 & {γ}_{y}\end{matrix} ] \\ {\vec{U}}_{T} = {[ I + {M}_{2} ]}^{- 1} ( I {\vec{U}}_{1} + \frac{4 {r}_{b}}{NT} {M}_{2} {\hat{n}}_{l} ) \qquad ( 20 )$$

where M₁ is the visual mass matrix of the bulk motion, assumed to have a 1:1 correspondence with applied motion, and M₂ represents the visual mass matrix of the illusory motion.

Parametric modeling of the curveball illusion enables predicting the perceived visual motion. Given a known outcome for perception, and setting the user's avatar to be represented by the illusory stimulus, it should be possible to affect the user's movement and haptic sensation during interaction in a virtual environment. But first, it is necessary to determine the perceived motion properties of the illusion, by identifying the visual mass matrices of Eq. (20). To this end, the following psychophysical experiment was conducted.

### Methods

Over 1.5 hours, 11 unimpaired healthy individuals, aged between 20 and 58 years, completed 180 trials in two blocks of 90. The method of adjustment was used to determine the psychophysical properties of the illusory motion. Subjects were asked to match the perceived motion, both speed and direction, of a moving illusory stimulus with that of a neutral stimulus while directing their gaze at the center of a radar disposed between the two stimuli and observing the stimuli with their peripheral vision. The neutral stimulus was a flat-shaded white sphere, while the illusory stimulus (described above) is a sphere with internal modulating luminance gradient.

To adjust the velocity of the neutral stimulus, the BAM was used. The configuration of the robot relative to a central point inside the radar controlled the velocity. When the device is centered, zero velocity is given to the neutral stimulus, and a dot representing the location is drawn corresponding to this at the center of the radar.

Upon moving the device with their hand, the location of this dot changes and imparts a velocity to the neutral stimulus, the vector from the center of the radar to this dot sets the neutral stimulus' velocity.

The virtual environment containing the visual stimuli was displayed to the subject through the piSight™ HMD, which is necessary, given that the stimulus must be viewed with peripheral vision; the HMD accommodates this requirement with its wide field of view. The background of the virtual environment was set to a neutral luminance of 0.5. Illusory stimuli were presented to the right eye in the periphery of the visual field, while the neutral stimulus was centered in the subject's field of view. Subjects were seated comfortably, and the BAM was positioned at a level near their dominant hand, for interaction. Gravity compensation was enabled to alleviate undue fatigue on the subject.

Before the start of the experiment, the dominant eye of the subject was ascertained through the Miles test for ocular dominance. This information was recorded for later comparison. Three out of eleven subjects were left eye dominant, with only one out of eleven being left handed. The leftie was also one of the left eye dominant folks.

For each trial, the parameters of the illusory stimulus were set, and the bulk motion of the stimulus proceeded to traverse the visual field in a vertical direction. Upon reaching a set height in the virtual environment, the stimulus was reset at its initial position and proceeded again to traverse vertically. In this way, multiple passes of the stimuli were seen over a maximum trial length of 30 seconds. Subjects could signal earlier if they felt confident in their adjustment.

The neutral stimulus was triggered to reset to its initial position when the illusory stimulus reset itself. Through experimentation, it was found that if the illusory stimulus was allowed to traverse the entire visual field, disappearing from the top of the HMD, edge effects occurred that attenuated the illusory motion and biased the result. Thus, the set height was employed inside the visual field at which the stimulus resets itself.

At the end of each trial, the final velocity of the neutral stimulus was recorded, along with the set parameters of the illusory stimulus. At this point, the subject was asked to rate their confidence in their estimate on an ordinal scale, from 1-5, 5 being most confident.

### Conditions

To investigate the parametric properties of the illusory motion, many parameters were varied. Five directions of the luminance gradient were tested, including: −π/2, −π/4, 0, π/4, and π/2. With the angles for θₗ set this way, it was possible to investigate the directional properties of the illusory motion induced by the modulation of the luminance gradient. Three values of vertical speed for the bulk motion were chosen, including: 508 mm/s (20 in/s), 762 mm/s (30 in/s), and 1016 mm/s (40 in/s). These speeds were chosen after several hours of testing and represent slow, medium, and fast movements typically made in the BAM's environment. The stripe modulation was governed by selecting one of three values for frequency, including: 0 Hz, 3 Hz, and 6 Hz. The 0 Hz condition was the control without illusory motion, although a static luminance gradient was shown.

The maximum frequency was chosen in conjunction with the periodicity of the luminance gradient to avoid aliasing at the 60 Hz screen refresh rate, and periodicity was fixed at N=4. The two higher frequencies roughly correspond to velocities of constant luminance near the chosen bulk motion velocities. Finally, the sphere radius was set to 76.2 mm (3 in), which visually appears to be about the size of a dime located approximately 80 mm from the eye. Finally the location of the radar was varied to appear in one of two places, either close to the center of the subject's field of view, or close to the illusory stimulus in the peripheral field.

In total, there were 90 conditions. The order of the conditions was randomized. Each subject completed two blocks of the 90 conditions, and the blocks were separated by a 15 minute break. With the repeated measures separated into blocks, it was possible to investigate if any learning, acclimation, or other changes occurred between the blocks.

General linear models in Minitab™ Statistical Software (Minitab, Inc., State College, Pa.) were used to assess the effects (p<0.05) of angle, frequency, radar position, and bulk motion on confidence and perceived properties of velocity with post hoc two-sided Tukey's Simultaneous tests.

### Results

As outcome measures, the confidence values reported by the subjects as well as their velocity estimates were examined. The velocity estimates were broken into their x (U_{T,x}) and y (U_{T,y}) components for analysis. In addition, U_{T,y} was further manipulated by subtracting the mean velocity from the user's estimate over the gross motion sub-groups; this centered value is denoted ΔU_{T,y}. For example, consider a single subject and a subgroup of that person's data where ∥\vec{U}₁∥=508 mm/s. The mean of this sub-group was subtracted from the individual values of the subgroup, and this process was then performed for the other two conditions of ∥\vec{U}₁∥. By carrying out these steps, the perceived illusory effect can be considered independently of the subjects' estimate for gross motion in the vertical direction. Such a manipulation is not necessary for the x component of velocity, because there is no gross motion in that direction.

A five factor ANOVA on the confidence values reported by the subjects showed significant effects of frequency and gross motion velocity. Post hoc testing reveals significant differences between all frequency and velocity conditions. Increased frequencies tended to decrease the subject's confidence in their result, while increased gross motion velocity increased their confidence level.

A five factor ANOVA on revealed significant effects of luminance modulation frequency (p<0.001), luminance gradient angle (p<0.001), block (p<0.001), radar location (p<0.012), ocular dominance (p<0.001), and gross stimulus motion (p<0.001) on the x component of perceived velocity, U_{T,x}. Post hoc testing showed many significant interactions between the parameters of the illusory stimulus on perceived motion.

Subjects had significantly higher estimates for perceived U_{T,x} with increasing modulation frequency, where a frequency of 0 Hz represents their estimate of the stimulus without circulation of the luminance gradient. The angle of the luminance gradient, θₗ, also led to significantly different estimates of U_{T,x}, with values of θₗ separated by multiples of π/4 leading to similar perceptions. The gross velocity of the stimulus showed significant differences in estimates of U_{T,x} between slow and fast conditions of ∥\vec{U}₁∥. Subjects estimated significantly higher values of U_{T,x} during the second block of testing, and the radar location had a negative impact on U_{T,x} when shifted closer to the illusory stimulus. Finally, right eye dominant individuals tended to estimate higher values of U_{T,x}, than those who are left eye dominant.

A five factor ANOVA on ΔU_{T,y} revealed significant effects of all factors excluding block, ocular dominance, and gross motion velocity. Post hoc testing revealed significant differences between all levels of frequency (p<0.001), in agreement with the results for U_{T,x}. Luminance gradient angle was found to significantly increase the estimate of ΔU_{T,y} by an approximately linearly amount. The radar location was found to have a significant effect, between locations (p<0.001), closer to the illusory stimulus nearly eliminates any measurable value of ΔU_{T,y}. Finally gross stimulus motion was not found to be a factor in this case for ΔU_{T,y}. The reasoning for this result is discussed below.

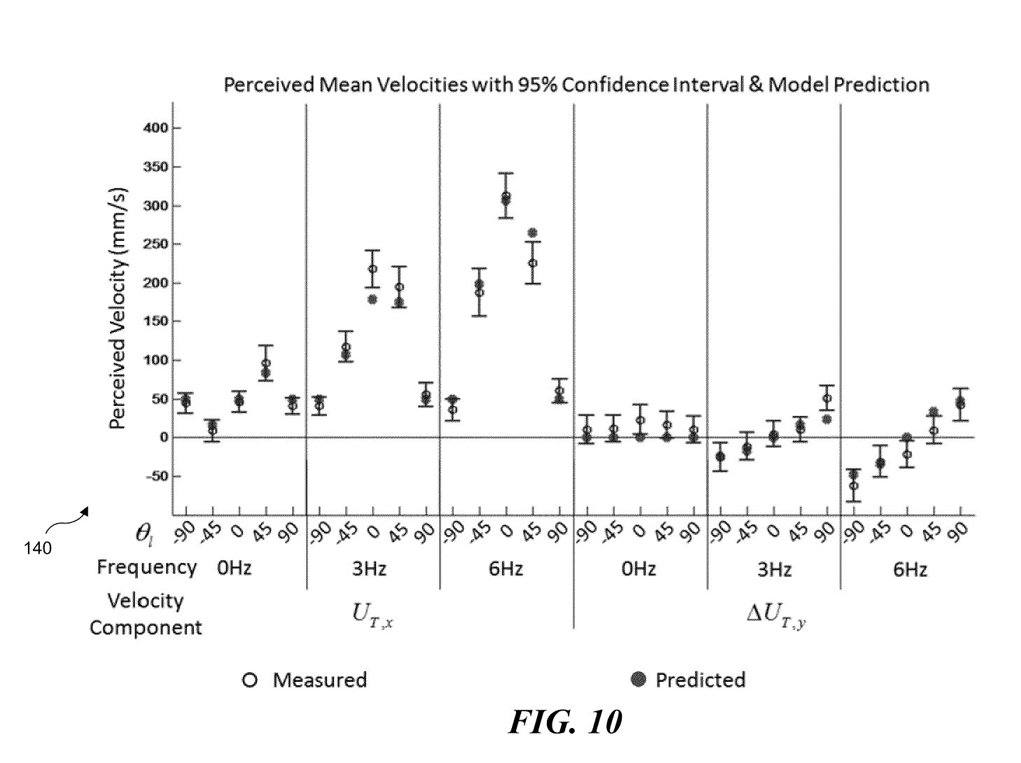

An interval plot showing the grouping of data means by frequency angle and velocity component is shown in a graph 140 in FIG. 10. The main effects described above can be seen, including the dramatic effect of the luminance gradient angle on perceived motion for both components of perceived velocity. FIG. 10 also shows the model fit for these data.

The model was fit with Matlab™ software using an optimization routine to minimize the sum of squared error of the means. A bias term was also added to the model in order to account for non-zero estimates of U_{T,x} when no illusion was present, as discussed below. Model predictions are shown by the filled circles of FIG. 10, actual data with 95% confidence intervals are shown by the open circles. Model parameter estimates from the optimization are listed in Table 1, below.

TABLE 1
Model Parameter Estimates for Perceived Motion Hypothesis

| | |
|---|---|
| Visual Mass Estimates | Model Bias Estimates |

| γₓ | γ_{y} | Uₘ (mm/s) | Uₒ (mm/s) |
|---|---|---|---|
| 1.283 | 0.117 | 76.82 | 114.68 |

### Discussion

The curveball illusion, which is based on the notions of peripheral drift and feature blur, has a dramatic impact on the perceived motion of the stimulus. When the direction of the luminance gradient is oriented perpendicular to the bulk motion, a strong perception of induced motion is generated, the magnitude of which depends on the modulation frequency of the luminance gradient, as is evident from FIG. 10. If θₗ orients the luminance gradient so that it is parallel to the bulk motion, then the bulk motion is perceived to be either faster or slower, depending on the sign of θₗ, and, as can also be seen in FIG. 10, Δ U_{T,y} appears to linearly increase with both θₗ and modulation frequency.

The fact that \vec{U}₁ does not have a significant effect on the perception of ΔU_{T,y} points to a well behaved linear phenomena that obeys the laws of superposition. This fact further points out that the perceived illusory motion is somewhat independent of the gross motion of the stimulus. Thus, its effects are solely attributed to the luminance gradient and can be measured repeatedly with invariance to \vec{U}₁.

These findings lend credence to the perceived motion hypothesis, i.e., that the visual momentum of the individual elements from the stimulus seem to be linearly related to each other. To test this hypothesis further, experimental data results can be predicted from the stimulus' parameters using the model and the accuracy can then be checked by running the experiment.

It can be seen from FIG. 10 that in the 0 Hz frequency condition, there are two biases in the subject's estimates of U_{T,x}. The subjects always estimate the stimulus to be moving with a small component of U_{T,x}, although there is no motion from the luminance gradient. It is believed that this result may be an artifact due to the spherical tiled screens within the HMD, and it is possible that the stereo projection was slightly misaligned or tilted so that the ball is seen to move marginally in the horizontal direction. Subjects also perceived larger and smaller values of U_{T,x} relative to their average, with only a visual rotation of the luminance gradient, frequency still set to 0 Hz. This bias persists when the frequency is increased, and therefore, it is not an artifact from the static case. So, it would seem that simply showing subjects a ball with a rotated striped pattern moving vertically can have a perceptual bias as well, when viewed peripherally. These two effects confound the model.

To account for this bias, the model can be slightly altered so that the optimization algorithm has a higher likelihood of converging. All that is required is to add a bias term into the x-component of \vec{U}₁. The \vec{U}₁ should ideally have no x-component, because only the vertical portion is set in the virtual environment. However, due to the perceptual bias of the HMD, and other confounding factors, subjects perceive horizontal movement according to

U_{l,x}=Uₗ sin(2θₗ)+Uₒ (21)

where U_{l,x} is the x-component of the gross motion velocity, Uₘ is the magnitude of the bias from the rotation of the stripes, and Uₒ is an offset owing to the spherical projection of the HMD.

With Eq. (21) augmenting Eq. (20), it was possible to find the visual mass and bias terms of the perceptual model (Table 1). The model does very well in predicting the data, and almost all of the predictions fall within the 95% confidence interval of the means. In accordance with the findings, the visual mass associated with the horizontal direction of motion is quite large, in fact almost 11 times larger than the vertical direction.

Taking into account the significance of the radar, location also has a bearing on model parameterization, which has not yet been discussed. The means that are fit to the data are averaged over all radar locations. Thus, the effective visual masses are only applicable with respect to those locations. As the stimulus nears the foveal region of the eye, its effectiveness becomes diminished. Therefore, for the model to apply, the stimulus must be well within the peripheral field.

The findings here are very exciting, since they show that perceived motion within a virtual reality environment can be drastically altered with the simple application of an illusion. This peripheral drift illusion has its own energy associated with it, and coupling it to the avatar of a user in a haptic environment could produce haptic illusions that are as yet undiscovered.

Unlike conventional visual distortion, which introduces dislocation between the user and their avatar, illusory motion generates a perceptual dislocation between the two. This effect can be used to the same advantage as traditional visual distortion, but with the added benefit of co-location. What was not known is whether perceptual effects from the visual system experiencing illusory motion can have an impact on a subject's haptic sensation in a virtual environment. To investigate this potential further, the interaction of the curveball illusion with a haptically rendered spring was investigated, as discussed below.

### Effect of Visual Illusion on Perceived Compliance of a Virtual Spring

Understanding the operating principles behind a particular illusion is necessary to its eventual application and effectiveness in directly manipulating perception in a virtual environment.

For the case of the curveball peripheral drift illusion, that understanding was developed, as discussed above. The following discussion examines the illusion's effect on haptic perception. The haptic interaction that was chosen is a spring, a common type of object found in virtual environments. The perception of spring compliance subjected to induced illusory motion from the curveball illusion was investigated.

Perception of compliance has been studied by many researchers under various experimental conditions. For example, pure un-distorted perception of compliance in the visual and haptic modalities for pinching between the thumb and index finger has been investigated by others in the prior art. An admittance control scheme was used to display a large range of compliances to the subjects, and combined visual-haptic estimates yielded smaller and just noticeable differences (JND) in compliance. The effect of scaled visual motion, or visual distortion, has also been investigated in the prior art by other researchers, again for pinching with the thumb and forefinger. These findings from the earlier research by others suggest that the perception of compliance is visually dominated. Delay of force and visual information was studied and reported in the literature, with comparisons between loading and unloading movements. The subjects pressed with their index finger on a virtual spring displayed using an augmented reality system with a phantom haptic device. The overall travel of the finger was less than 80 mm. The authors of the prior art report of this investigation found that a delay in force information increased perceived compliance, while a delay in visual information decreased perceived compliance, and that a subject's perception is mostly due to the loading phase of spring compression. Also, the JNDs increased for perception with only unloading information, but was similar between loading and combined load-unload phases.

In the present study, the device being used has a large work-space and enables the perception of compliance for a whole arm reaching motion. In other words, it is possible to address the question of how an entire arm/hand system perceives compliance. This function has not been covered in the literature, although perception for finger-hand interactions is well known. Furthermore, because the present system has the unique capability of being a hybrid-haptic device, due to the telescoping mechanism, it provides the opportunity to investigate the difference in perception between a spring rendered with a motor as compared to a spring rendered with a brake, as well as considering the effect of illusory motion.

### Methods

Over a test period of 1.75 hours, n=8 healthy subjects with normal or corrected-to-normal vision progressed through 440 randomized trials to determine their perception of compliance under a variety of conditions. Each trial consisted of a two-alternative, forced-choice discrimination, where the user interacted sequentially with two virtual springs and then chose the spring that they perceived to be more compliant (i.e., ready to deform in response to an applied force). The choice was made using a built-in joystick on the BAM's handle, and thus, the experiment was self paced.

Before the experiment, subjects were instructed in the definition of compliance. Compliance was demonstrated empirically by having the subject push on the cushions of a two different pieces of furniture. All eight subjects were able to distinguish the cushion that was more compliant (more readily deformable) than the other cushion.

In a standing position, the subject's hand directly manipulated the free end of the spring, so that an extension of the arm compressed the spring. Visually, their hand was represented by a stimulus corresponding to the curveball illusion, depicted in FIG. 9, and the avatar's initial position lay in the right hemisphere of the subject's field of view. A goal line was also displayed in the left hemispherical field of view. The virtual spring was located between these two visual elements but was not graphically shown. The initial distance between the annular disk at its starting position, corresponding to the initial avatar location, and the goal line was ˜203 mm (8 in).

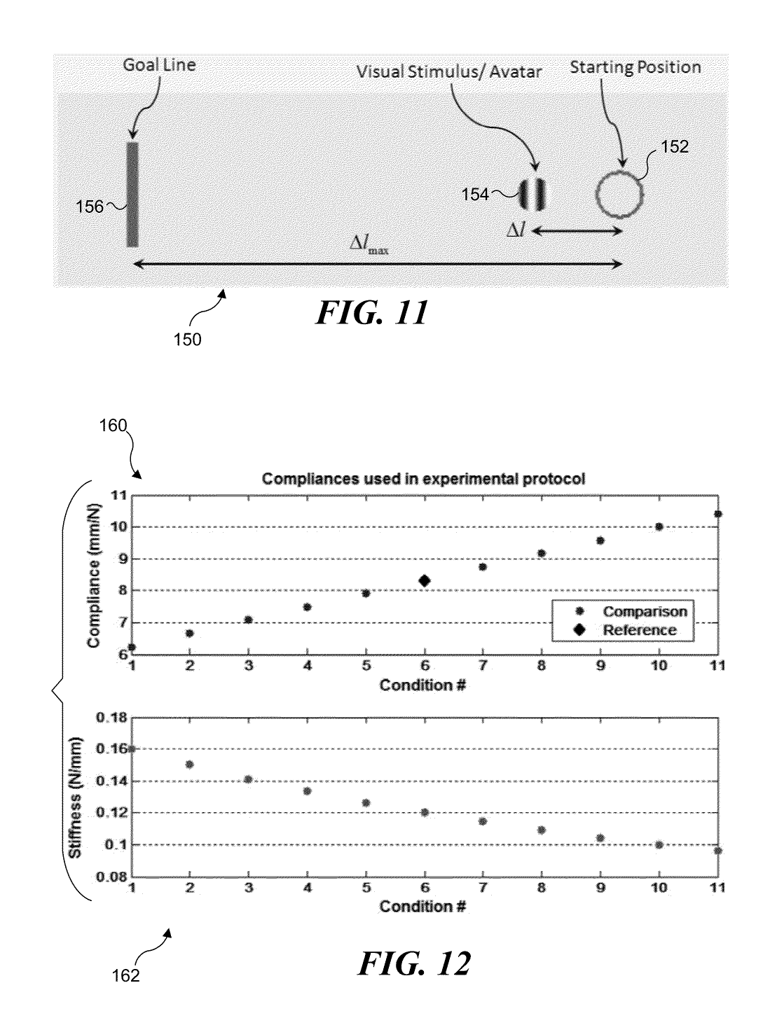

As shown in a schematic view 150 of the test environment in FIG. 11, a successful load-unload phase of the spring was completed when the subject manipulated their avatar 154 to touch a goal line 156 and then moved it back to its initial position 152, which was indicated with a circle. Subjects were instructed to make smooth motions without stopping, even once they reached the goal line. Subjects were allowed to take a break whenever they felt necessary and were encouraged to take a break every 100 trials.

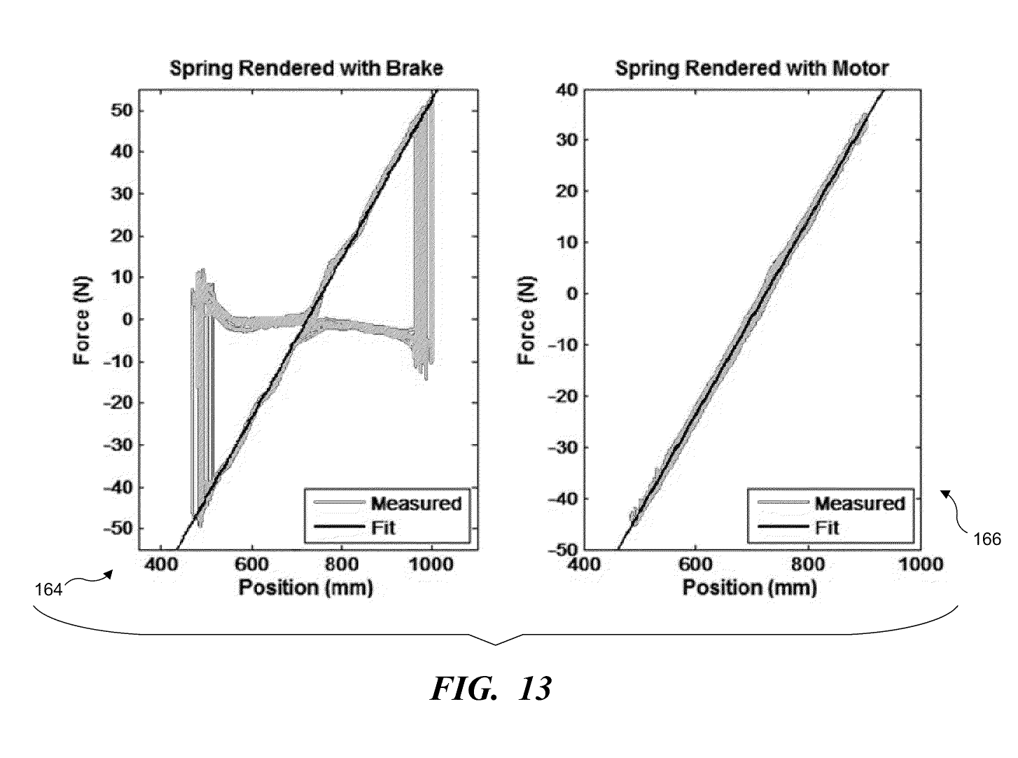

Of the two springs presented for comparison, one spring was a fixed reference compliance displayed with the prismatic joint's motor, while the compliance of the other spring was randomly selected from eleven comparison compliance values, which are shown for compliance in a graph 160, and for stiffness in a graph 162, in FIG. 12. The compliance values were chosen so that the perceptual difference between the minimum and maximum with respect to the reference (median) is large enough to easily discriminate between the extremes. Careful selection of the minimum compliance is necessary to reduce the effects of fatigue on the subject. The presentation order of the reference and comparison compliance was randomized between trials. The reference compliance was chosen to be the median value of the comparison compliances, and thus, the proportion of forced choices determining compliance between the comparison and reference in this case should be 0.5, but may differ based on conditions. Conditions were imposed upon the display of the comparison compliance, i.e., the display was shown either with or without the curveball illusion, and rendered with either the brake or motor (for purpose of providing a more conventional reference). The specifics of the chosen rendering algorithm and parameters of the curveball illusion are discussed below. To gather sufficient perceptual data, each condition was repeated ten times.

The virtual environment was presented to the subject through the piSight™ HMD, and an environmental occluder was draped over the HMD to obscure the subject's vision of their own motion. Masking noise was played through headphones to the subject to focus attention on the comparisons and hide the difference in mechanical noise caused by different modes of actuation.

Haptic Display of the Virtual Spring with Brake or Motor

To display the effect of the virtual spring in the virtual environment, two types of actuators were displayed, enabling selection of either a brake or a motor that are built into the telescoping mechanism for friction compensation. Note that the motor was used in this experiment simply to provide a comparative reference, since the intent is to show that a passive brake actuated robotic device that does not use a motor can appear to a user to be as controllable as a motor driven robotic device, by using the distortion provided in a virtual environment to alter the user's perception so as to compensate for limitations of the brake actuated device. Displaying the spring represented with the brake was accomplished using the interaction controller with friction compensation. The interaction controller accurately controls the desired spring force based on the user's displacement during the compression phase of spring display. As a result of the controller design during the unloading, extension phase, the brake was turned off, and only the effects of friction compensation were felt. The force/position curves generated with the interaction controller using the brake can be seen in a graph 164 on the left side of FIG. 13 for a desired compliance of 5.71 mm/N (1 in/lb). A linear fit on the loading phase yields an R² of 0.99 and estimates the compliance to be 5.15 mm/N (0.903 in/lb). During the loading phase, force can be seen to track accurately, while the unloading force is reduced to a minimum with friction compensation.

A motor driven display of the virtual spring is also accomplished with the interaction controller, except the passivity check is disabled for purposes of this experiment, enabling the motor to do work on the environment. Good force tracking is achieved using this method. Force position curves during the loading and unloading phases of spring interaction are shown in a graph 166 on the right side of FIG. 13, for a desired compliance of 5.71 mm/N (1 in/lb). A linear fit on the data estimates the compliance to be 5.25 mm/N (0.921 in/lb) with an R² of 0.99. The interaction controller ensures that the subjects experienced a force that reflect the desired spring compliances.

The control software used in this study is able to dynamically switch between the two methods of control, depending on the trial conditions and on whether the reference or comparison compliance is displayed. When the user completed a load, un-load phase, the device position was locked with the brakes upon representation of the controlled object re-entering the start position circle, which represents the free length or initial position of the spring. Motion along the pitch axis was restricted by saturating its brake, relieving the duty of gravity compensation in this situation. Yaw axis motion was un-restricted, to allow a natural freedom from the user's arm, although the spring was only rendered along the prismatic joint.

### Illusion Parameters

The effects of illusory motion perceived in the curveball illusion are analyzed above, and as a result, it was possible to choose parameters so as to be consistent with the direction of a user's motion, while eliciting perceived motion. Interaction with the virtual spring was constrained visually along a straight line. Therefore, the direction of the luminance gradient should be oriented parallel to this motion.

The findings set forth above for the curveball illusion indicate that perceived velocity can be manipulated parallel to the direction of bulk motion. Perception of compliance, however, requires continuous sensory integration of both force and position during the interaction. The effect that was observed with the curveball illusion appears to create an offset in perceived velocity with a constant stimulus frequency. To affect the perception of compliance, the decision was made to alter the perceived acceleration of the object, thus distorting the subject's information about force and position. To accomplish this goal, the stimulus frequency can be manipulated as a function of the user's position.

Consider the illusory stimulus moving with a constant bulk motion. If the modulation frequency of the luminance gradient is then varied sinusoidally over the stimulus path, the stimulus will appear to slow down and speed up. Thus, the perceived acceleration of the object is manipulated, as well as its position. This effect seems to be invariant to foveal or peripheral viewing, and thus, the subjects were instructed to look straight ahead during the interaction so that the stimulus crosses their visual field.

If the luminance modulation frequency from Eq. (16) is simply made a function of position, then discontinuities will result in the color gradient as position is varied. These discontinuities stem from the linear progression of time in Eq. (16), versus a positionally varying driving frequency. Thus, the frequency component is seen to step or jump as the stimulus is moved. A smooth change in luminance is desired, given a varying frequency, and to accomplish this result, the frequency component, f(x,t), of the luminance signal, C(x,t), can be integrated, modifying Eq. (16) to yield:

$$\begin{matrix}F ( x , t ) = {\int }_{0}^{t} 2 π f ( x ( t ) ) d t & ( 22 ) \\ C ( x , t ) = \frac{1}{2} cos ( F ( x , t ) - \frac{N π}{2} ( \frac{x}{{r}_{b}} + 1 ) ) + \frac{1}{2} & ( 23 )\end{matrix}$$

where f(x(t)) is the function that relates modulation frequency to stimulus position. Taking the derivative of Eq. (23) with respect to time yields the velocity of a constant luminance value over the stimulus,

$$‖ {\vec{U}}_{2} ‖ = \frac{4 {r}_{b} f ( x ( t ) )}{N} . \qquad ( 24 )$$

Taking another derivative of Eq. 24, using the chain rule, results in the acceleration of a line of constant luminance over the stimulus with positionally varying frequency modulation,

$$‖ {\vec{U}}_{2} ‖ = \frac{4 {r}_{b}}{N} \frac{d f ( x ( t ) )}{d x} \frac{d x ( t )}{d t} . \qquad ( 25 )$$

The question remains how to choose an appropriate function for f(x(t)). To determine this function, the change in a user's velocity profile during interaction with springs of different compliances was considered. If it was known a priori how the velocity profile changes when interacting with springs of different compliances, that knowledge informs the generation of f(x(t)). Humans typically make bell-shaped velocity profiles when reaching between targets, according to the equilibrium point hypothesis, but it is not clear how this profile changes when exposed to various external compliances. Preliminary data were taken from two subjects interacting with virtual springs rendered with the motor of the prismatic joint. Velocity profiles from 100 interactions, i.e., 10 interactions with 10 different compliances, were recorded.

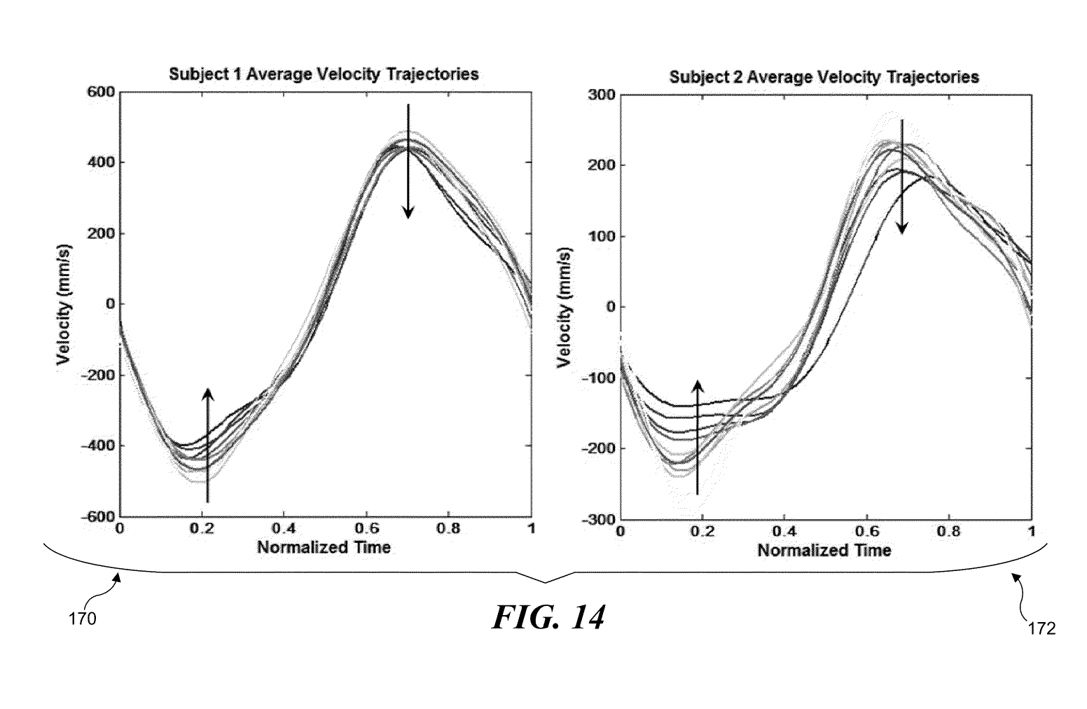

Velocity profiles were normalized in time and averaged across compliances, and then plotted against the velocity profiles of a reference compliance (the median of the 10 tested compliances) to discern any differences. The velocity profiles of two subjects are presented in graphs 170 and 172 in FIG. 14. It can be seen in this Figure that increased compliance tended to generate smoother and more bell-shaped profiles. Intuitively, this result makes sense at the limit, since with infinite compliance, the hand/arm has no external force acting on it. With decreased compliance, the profiles tend to flatten out and not be as peaky, which is a cue for determining how f(x(t)) should be modeled. First, the bell shaped velocity profile of a user was approximated with a half period of a sinusoidal function corresponding to the total change in spring length, Δl_{mzx}, during the interaction (203 mm). Because a scaling of the velocity profile was observed, the chosen modulation frequency scales this sinusoidal approximation. The change in velocity profile was observed to be in the same direction during both loading and unloading phases of the virtual spring, and therefore, the sign of the modulation frequency is flipped, depending on the user's velocity. Based on the results discussed above, the magnitude of the frequency modulation was chosen to be 6 Hz, since this value previously induced the largest perceived effects. Hence f(x(t)) is defined to be,

$$f ( x ( t ) ) = \{ \begin{matrix}- 6 sin \frac{πΔ l}{Δ {l}_{max}} & \dot{x} \geq 0 \\ 6 sin \frac{πΔ l}{Δ {l}_{max}} & \dot{x} < 0.\end{matrix} \qquad ( 26 )$$

### Luminance Selections

Finally, the luminance values of the other objects in the experiment's environment, relative to the luminance of the stimulus, was considered. For maximum effect, the luminance of the surrounding elements should be neutral (0.5), and therefore, the goal line area and the annulus representing the initial position was set to a medium gray. To help the subject differentiate between the first and second comparisons of each trial, the background colors were set to red for the first spring interaction and to a dark green for the second interaction. Both the shades of red and the dark green that were chosen have luminance values of 0.5. The selection screen, where the discrimination was made, showed two targets, including one colored red, and the other green. This color presentation visually reminded the subjects of the interaction they believed to be more compliant when making their selection.

### Results

The discrimination data from the experiment were analyzed separately for each subject. The proportion of haptic stimuli reported to be more compliant than the reference value at each simulated spring compliance was fitted with a cumulative Gaussian distribution using PSIGNIFIT, and this distribution is the psychometric function for each subject. From the psychometric function, the point of subjective equality (PSE) was determined as the compliance corresponding to a proportion 0.5. The just noticeable difference (JND) was computed as the difference between the PSE and 0.84. The PSE is the value of the comparison compliance, subject to experimental conditions, which is perceived to be equal to the reference compliance. The JND is the smallest detectable difference in compliance that the subjects can reliably discern between the reference and comparison stimuli (84% of the time).

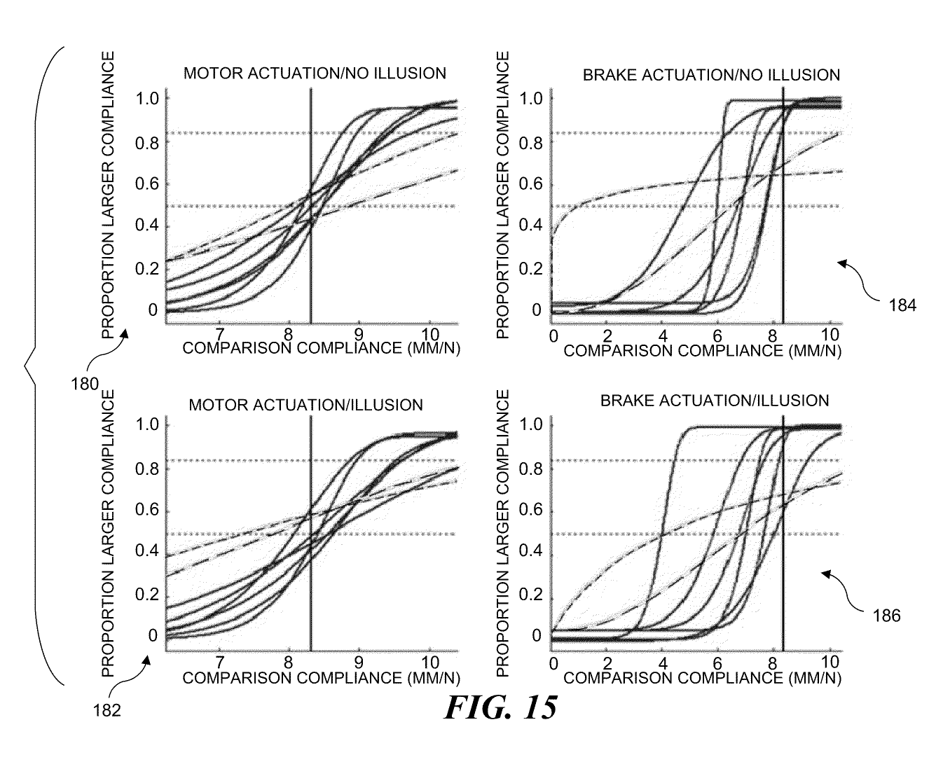

Psychometric curves for all conditions across all subjects are shown in FIG. 15, where solid lines represent subjects with normal haptic sensitivity, while the dash lines denote individuals with much lower thresholds. Motor actuation with no illusion is shown in a graph 180, and with illusion in a graph 182, while brake actuation with no illusion is shown in a graph 184, and with illusion in a graph 186. The reference compliance stimulus is denoted by the vertical black line, and this reference was felt during each discrimination trial.

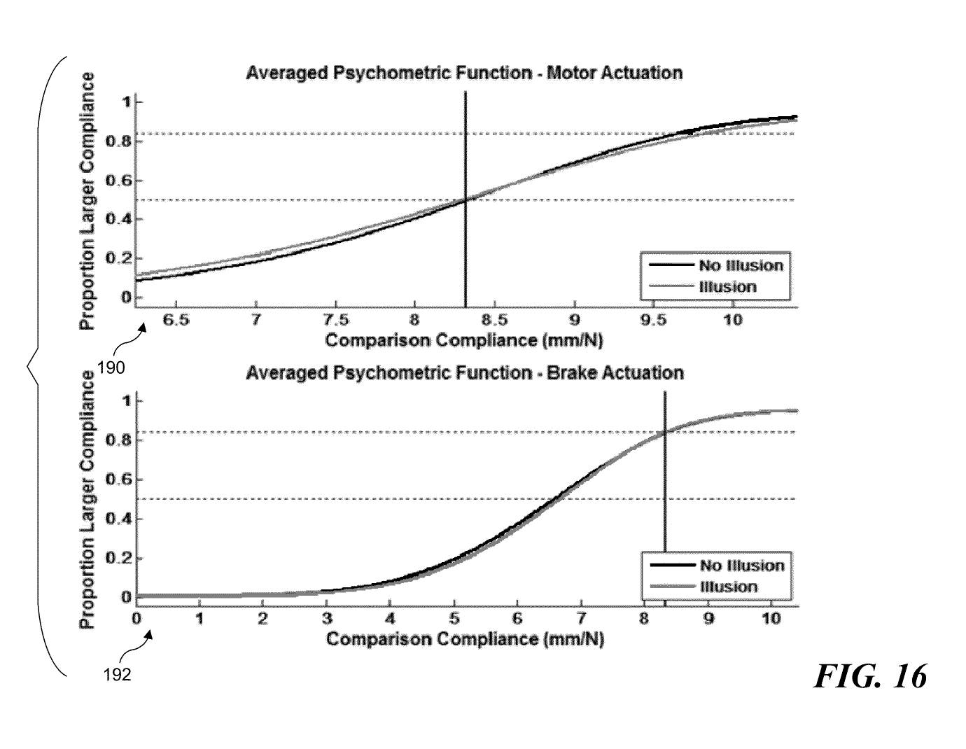

The horizontal lines in FIG. 15 indicate the 0.5 and 0.84 proportion levels used to calculate the PSE and JND. Averaged psychometric functions, taking into account all user data, were also constructed for comparison. As noted above, the left plots of FIG. 15 show the perception of compliance for conditions where the comparison was rendered with the motor, and the green line indicates the presence of illusory stimuli. Also as noted above, the right half of FIG. 15 presents the overall psychometric curves with the brake generating the haptic stimuli of the comparison values, both with and without illusory stimuli. Points of subjective equality were found numerically, as the intersection of the psychometric curve with the line of constant proportion 0.5. For the calculation of both the PSE and JND, the two subjects with dramatically different thresholds for haptic perception were excluded; these two individuals are denoted by the dash lines in FIG. 15. The values calculated from the curve fits bias the mean PSE and JND. In the condition with the motor displaying the comparison stimulus, the PSEs were found to be 8.427±0.0838 mm/N and 8.362±0.0621 mm/N, respectively, with and without the illusory stimulus. For compliance simulation with the brake, the PSEs are 6.528±0.592 mm/N and 6.627±0.452 mm/N. respectively, with and without the illusory stimulus. The PSEs for all conditions are compared in FIG. 16, where the motor actuation is shown in a graph 190 at the top of the Figure and the brake actuation is shown in a graph 192 at the bottom of the Figure.

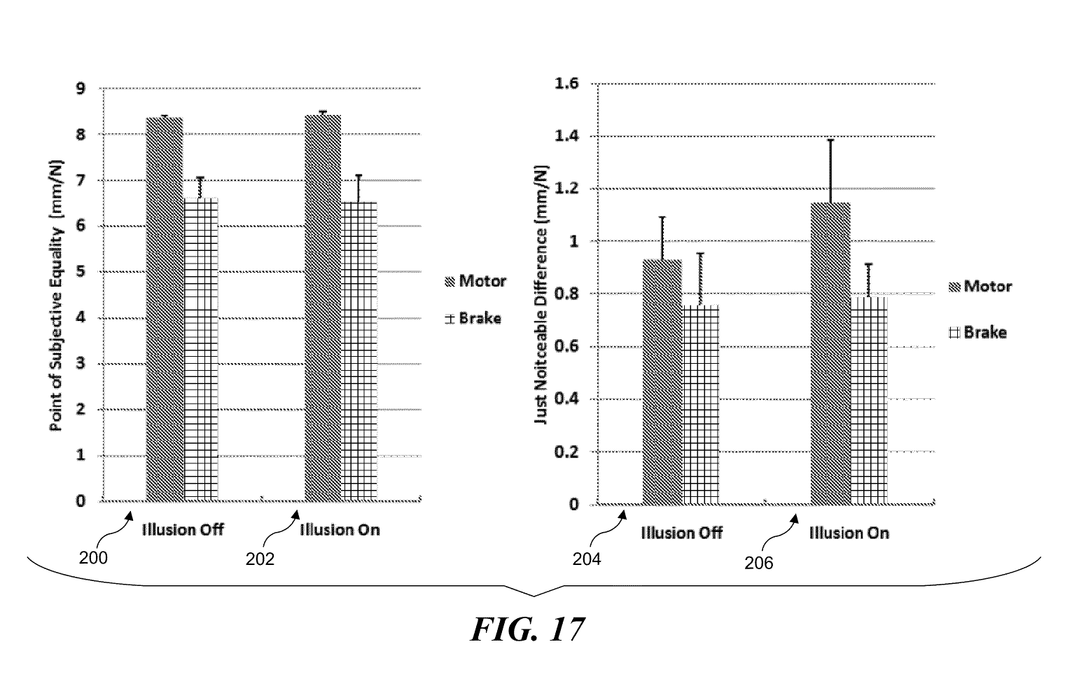

In the condition where the motor simulated the spring, the JND for compliance was found to be 1.146±0.239 mm/N and 0.930±0.162 mm/N with and without the illusory stimulus, respectively. This result corresponds to Weber fractions of 13.76 and 11.17 percent with respect to the reference stimulus. For the brake actuated condition, the JNDs were 0.787±0.129 mm/N and 0.756±0.20 mm/N, respectively, with and without the illusory stimulus. Weber fractions for the brake actuated condition were 9.45 and 9.08 percent. This information is shown in graphs 200, 202, 204, and 206 in FIG. 17.

A two-way ANOVA on the PSE showed no effect from the illusory stimulus, but there was a significant effect from actuator choice (p<0.001). Post hoc testing revealed a significant difference (p<0.001) between mean PSEs generated by the motor and brake, with the brake actuation condition developing much lower average PSEs. A two-way ANOVA on the JND showed no effect from either the illusory stimulus (p>0.5), or the choice of actuation (p>0.16), although there was a positive change in the mean JND in the condition with illusory stimulus.

### Discussion

The main results from this experiment reveal the JND for compliance of the whole arm as a gross motor system interacting at the hand. The Weber fraction found in the control condition, with motor actuation and no illusory stimulus, was 11.17%, which implies that the human perceptual system cannot discriminate between compliances that differ by less than 11.17%. For pinching and finger manipulation tasks, the Weber fractions have been found by other to be higher, 16% and 22%, respectively, although the presence of a visual terminal force location (upon fully compressing a spring) has also been shown in these prior art studies to decrease the Weber fraction to ˜9%. It may be possible that the JND values noted above reflect a decision to show a goal line, such that the subjects have a fixed visual reference with which to make their comparisons, and thus provide more accurate responses.

A striking difference between the perception of compliance is demonstrated to be dependent upon the actuation method. This effect can be seen in the distribution of individual psychometric functions of FIG. 15, as well as in the averaged psychometric functions shown in FIG. 16, where the PSE is seen to change significantly. The cause of this effect is most likely the brake's approximation of the spring's restorative force. For a braked system with friction compensation, the closest approximation is achieved by turning off the brake. Otherwise, the user will feel resistance as they unload the spring. The consequence of this method is that the user must pull the device to unload the spring, whereas with motor actuation, the user resists the potential energy stored in the spring until the spring is relaxed. Thus, there is a fundamental sign difference in the applied user force when unloading the virtual spring, which most likely caused discrimination confusion in the subjects, in the tests reported in detail above.

The loading curve for the spring with brake and motor are nearly identical; however, the unloading phases vary to a greater extent. In the tests using the brake, unloading requires only enough work to overcome the latent friction after compensation, and this energy expenditure is much less than that required to resist the potential energy stored in the compressed spring. Thus, there is a perception that the braked mode of actuation is always more compliant. This perception may arise if the subject judges the overall compliance of the spring on both the load/unload phases, or solely the unload phase. No specific instruction was given to the subjects with regard to what phase of their motion within which to judge compliance, and as a result, there is the dramatic difference in PSEs between motor and brake actuation. In order to match compliance perception using the brake to that of the motor, a much stiffer object needs to be rendered, which is reflected in the shift of the PSE.

Two subjects had difficulty overall discriminating between compliances, their PSEs and JNDs are not included in the summary statistics in section 6.5.2. This effect can be seen qualitatively within the individual psychometric curves. These subjects are demarcated by the solid and dashed red lines in FIG. 16. Overall they had high variances in their cumulative Gaussian distribution leading to large JNDs, in the case of discriminating with the braked mode of actuation, one subject hovered around a proportion of 0.5 for all levels of compliance, which indicates an inconsistency with the subject's discrimination strategy. Perhaps, that subject judged occasionally based on the loading phase, and at other times, based on the unloading phase.

No significant effects were observed due to the presence of the illusory stimulus, but this result could also owe to the fixed visual reference of the goal line. However, the results from the earlier tests point to another cause. It was shown in the earlier experiments discussed above that the visual mass in the direction perpendicular to the gross motion of the stimulus is ˜11 times larger than in the parallel direction. Therefore, this experiment is predicated on what is a perceptually small illusory effect. In order to affect the haptic modality through vision, it is necessary to maximize the perceptual effects of a given stimulus.

In further experiments that are contemplated, it would be useful to examine cross modal effects of the illusory stimulus operating in its direction of preferred visual mass. A similar experimental design could be used, since the only change required is to reorient the virtual spring with which the user interacts so that a large component of the motion is perpendicular to the spring force. To decrease the duration of the experiment, an adaptive staircase method could be used to determine the JND, although such a method doesn't define the tails of the psychometric function as well, and a cumulative Gaussian distribution can still be fit to estimate them.

### Exemplary Application—Rehabilitation by Distortion

“Learned non-use” is a significant problem in stroke and other motor impairment. When stroke survivors learn to manage daily activities without using the formerly paralyzed limb, they often end up with less functional ability than what their neuro-muscular system is actually capable of achieving. In essence, they have learned to use their limb with less than its full capabilities, in terms of strength and range of motion. Constraint-induced therapy is a popular and effective way to constrain the able limb to force patients to use the affected limb. However, this type of therapy causes the unaffected limb to lose motor ability, and the cast that constraint-induced therapy requires is cumbersome to wear for an extended period of time. To remedy these problems, the distorted virtual robotic environment can be applied to expand a patient's movement and strength to its full potential. For example, a stroke patient with a paralyzed limb can be immersed in a virtual environment, while a comfortable robot coupled to the paralyzed limb monitors the adaptation states and coordinates the movement of all of joints to promote neural rewiring. To ensure that patients reach their full mobility potential, the present technique creates a virtual environment to provide visual feedback that is slightly different from, or “distorts,” reality.

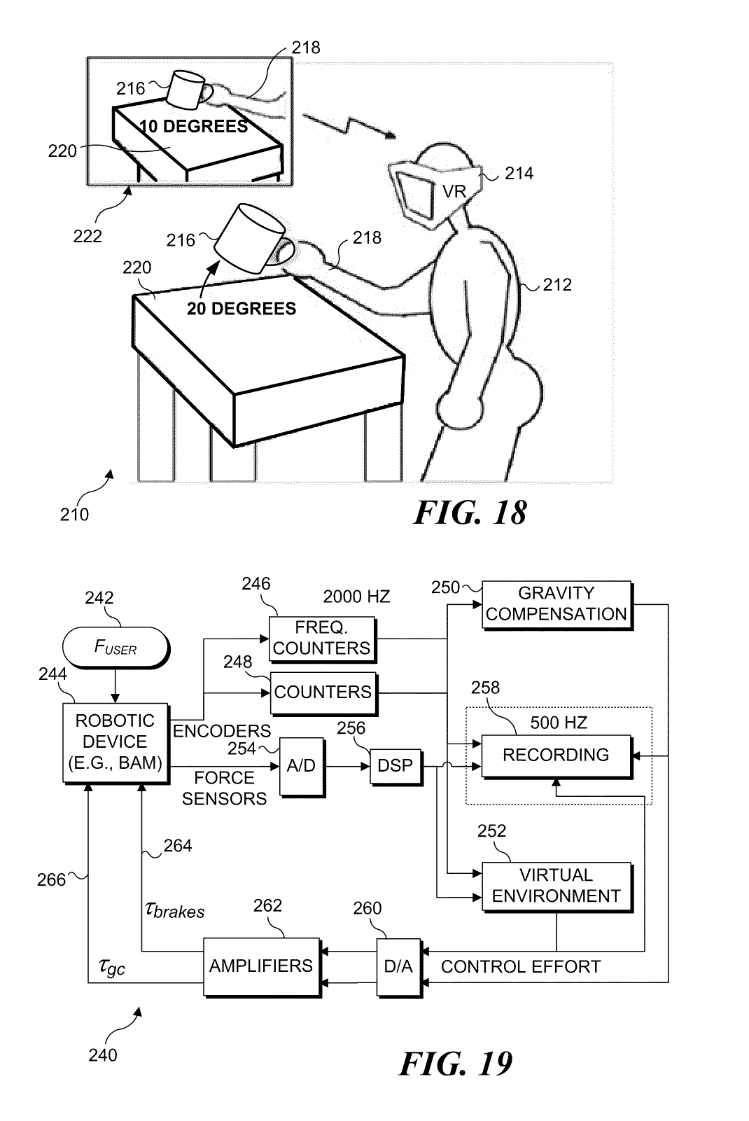

Consider a scenario in which a patient's limb that is to be rehabilitated is occluded from view. A computer-controlled environment displays a virtual limb representation, but illustrates the virtual limb as moving slightly slower than the limb is, in reality, moving. Because, as noted above, visual feedback is more acute than proprioceptive feedback, the patient “believes” the false visual feedback (rather than the actual proprioceptive feedback from the limb that is being moved) and therefore moves according to the visual feedback. If the patient sees the virtual limb on the visual display moving more slowly than was intended by the patient, the patient will exert more effort to move the actual limb faster. As a result, the “perceptual gap” between the patient's perceived and actual movements motivates the patient to move farther and more forcefully than would have been done with an undistorted visual feedback of the actual limb. A comparison of the distorted perception of a subject 212 using an arm 218 for moving a cup 216 from a table top 220, as seen by the subject in a HMD 214 as a virtual environment 222, relative to the actual movement of the cup, is shown in a schematic view 210 in FIG. 18. Although a cup is shown as the “load” being moved, the patient will normally grasp a handle of the BAM or a component of any other robotic device that is to be manipulated in the rehabilitation exercise. This exercise may be repeated a number of times at each session. The virtual reality can portray the component being moved by the patient as a cup or almost any other object, rather than showing the component as simply a handle of the robotic device. When the virtual environment display is removed, the patient's perception returns to normal, but the patient's muscles remain stronger and more coordinated as a result of the repetitive rehabilitation therapy and exercise.

The use of the distorted virtual environment is particularly useful not only for stroke patients, but for patients with motor impairments caused by other types of central nervous system trauma, and even those with perceptual or cognitive deficits that prevent them from reaching their full potential. The term “Rehabilitation by Distortion” (RBD) was coined for this rehabilitative paradigm, as an example of one application of the distorted virtual reality used in connection with a robotic device.

### Gaming Environment

For therapy to work, the therapeutic environment must be stimulating enough for patients (even those with little motivation) to use it several times a week. The most engaging environment identified for this purpose thus far incorporated was the Hangman game. In this game, players have seven tries to guess the letters in a word. Letters are chosen by moving the motor-impaired joint, and word sets are chosen from a theme that differs daily. For example, the theme could be “animals,” and all words to be guessed that day were drawn from this category. In studies that were performed, four disabled subjects stayed engaged throughout their therapy sessions and gave a 4.0 average score for this category (where the scale ranged from 1 (boring) to 5 (extremely engaging)).

To learn what patients in an elderly population might find “engaging,” five nursing home residents (ages 72-89) were asked to rank six games in the order they would prefer to play them in a virtual robotic environment. The results (sum of ranking divided by the number of subjects) were: bowling (2.6), tennis (3.0), Sudoku (3.0), golf (3.4), crossword puzzles (3.8) and Hangman (4.4). Bowling was most exciting for those who had bowled on the Nintendo Corporation Wii™, and they enjoyed the competitive aspect of having real opponents. For demo purposes, a tennis environment was programmed in which the tennis ball flies to different positions, and the BAM must be swung by a subject like a tennis racket, with the desired trajectory and speed to return the ball; there is haptic feedback on the user when the ball hits the tennis racket, as represented in the virtual environment. Again, the level of distortion of one or more characteristics of the motion of the control element on the BAM as represented in the virtual environment, such as velocity, speed, acceleration, direction, or extent of movement, can be adjusted to induce a patient to exert more strength and range of motion or move in a different direction, than the patient would if actually viewing the undistorted movement of the control element of the robotic device that is being moved by the patient.

### Other Applications

The present novel approach can also be applied to a variety of other applications. For example, distortion of a virtual environment being viewed by a user can be employed to enhance or alter the user's perception of virtual objects in the environment that are interacting with a force feedback device. While a force feedback device, such as a haptic joystick, can provide only a very rough approximation of the feedback resulting from a user's applied force, the user's visual perception of the virtual object being controlled with the force feedback device can greatly enhance the realism of the feedback provided to the user by the force feedback device.

For other input devices, such as a mouse, the visual distortion provided on a display screen can alter the visually perceived characteristics of the mouse and the pointer that it controls. For example, when a user is moving the pointer or cursor with the mouse, the visual distortion can make the pointer seem to be drawn toward a selection, as the pointer moves near a selectable entity that the software controlling the pointer has been programmed to assist the user in selecting or repelled from a position in the displayed virtual environment. This visual distortion might be useful for enhancing the user's interaction with web pages or other types of interactive software, or might be employed to help disabled individuals to more easily navigate on a displayed document or web page, so that they can more readily manipulated the pointer or cursor while using a computer.

The visual distortion provided in a virtual environment or other displayed material can be applied to redirect or manipulate a user's arm or hand or finger motion while moving or operating an input device, and serve as a stimulus with visual feedback of the user's interaction with the input device. For example, when a user is moving a pointer over a web page, the motion of the pointer might be distorted so as to seem to be drawn to a “sticky” advertising hyperlink, making it appear that the pointer doesn't want to be moved away from the hyperlink. A user would thereby be encouraged to select the hyperlink and be exposed to the advertising of a product.

Since visual perception on a display overrides a user's haptic impression, a visually distorted display can alter the user's perceived force characteristics during virtual interactions between objects displayed to the user compared to the actual input force provided by the user. Thus, in a game, the force applied to a non-haptic feedback joystick could seem to be resisted by displaying the virtual object being manipulated by the joystick so that it seems to be slowing as the user continues to control the joystick to advance the virtual object when pushing another object in the virtual environment. The user would thus perceive the object being pushed as producing a force that resists the user's attempts to push the object.

There are many other applications in which a distortion of one or more characteristics of motion displayed in a virtual environment might be of benefit in altering a user's perception of reality. The above examples are therefore not intended to be limiting in any respect.

### Robotic Device

There are certain considerations in producing appropriate passive robotic devices usable in a domestic applications and intended to interact with subjects who are viewing a distorted virtual environment. Clearly, the constraints on size and (and corresponding costs) are different in connection with robotic devices intended for use with a distorted virtual environment in commercial applications. The following discussion pertains to robotic devices used for domestic applications, such as for carrying out rehabilitation exercises in a patient's home.

To provide sufficient force to support the subject's limb and to provide a small amount of additional forces for those who can benefit from resistive training, an exemplary robotic device can include one or more vertical joints that can support a gravity-directional force and create a variable resistance using an adjustable clutch mechanism. The portion of the robotic device that is manipulated by the subject should be movable relative to six degrees of freedom. The adjustable clutch mechanism can include interleaved friction disks, a portion of which are coupled to each linkage. A solenoid or other electronic mechanism can apply normal forces to the friction pads of each clutch to vary the joint resistance, producing an electronically controlled brake. Joint resistance should be adjustable according to the exercise being performed or other criteria, via a software setting. This mechanism should be sufficient to protect the arm or other appendage against gravity. For example, if a subject tries to lift an arm but the arm begins to drop, the clutch can be programmed lock up, arresting the arm's fall. Once the subject again tries to raise the arm, the clutch can decouple, returning the joint(s) being manipulated by the subject to a low-friction state.

To spare subjects from lifting the weight of the component of the robot device that is being manipulated by the subject, a passive spring-based gravity compensation mechanism can be included. Such a compensation mechanism is relatively simple to construct, requiring only a four-bar linkage, a spring, a roller, and a cable.

The robotic device for home use should typically be sufficiently small to operate in a workspace of about 1.0-1.3 cubic meters, which should be more than adequate to enable a subject to carry out large whole-limb movements of an arm or a leg. To detect joint position, the robotic device can employ rotary optical encoders or other types of rotary position encoders. Effective encoder resolution can be increased by gearing up the joint motion relative to the encoders. The robotic device should have 1 mm positional accuracy at the endpoint of it motion, which corresponds to a maximum extension of 1 m long. Without gearing up, the encoders should have a resolution of about:

[tan(1 mm/1000 mm)/2π]⁻¹=6283 counts per revolution(cpr)

However, with a 1:10 gear ratio, only a 628 cpr encoder would be required, reducing cost. Potentiometers might alternatively be used for encoding rotary position, as a cost-saving measure.

To detect the end-tip force and to provide further refinement in position detection, strain gages can be included, e.g., one on one of the linkages and the other in the base. These strain gages should have a resolution of 0.5 Newtons (or 0.05 kg). A custom-made circuit can be employed to condition the signals.

Joint position and strain gage information can be converted to indicate the arm position, orientation, and force. These parameters are used by the software controlling the robotic device and the accompanying virtual environment visualization, e.g., to control the clutch, and can also be recorded or logged so that a physical therapist can monitor patient progress.

The device can be connected to a personal computer (PC) via a universal serial bus (USB) port and can be powered by an AC adapter or other appropriate power supply. Electronics in the base of the device can interface the encoders and solenoids with the USB port. Software executing on the PC (or other type of controller) should be designed to: (1) read tracked motion from the encoders and enable visualization of the motion with an OpenGL (or other appropriate) model of the robot device's joints; (2) conduct system identification of components for accurate control; (3) control the clutches; and, (4) run applications with arm gravity compensation for assisting to rehabilitate those with motor impairment. FIG. 19 illustrates the control functionality provided in such a system. The application or training program can be displayed on a normal computer monitor or in other types of displays, such as a HMD, and can be implemented with different force resistance levels and with/without distortion of the movement characteristics displayed to a subject in the virtual environment, for demonstration purposes.

A functional block diagram 240 for controlling the robot device and the display in regard to the present novel approach is shown in FIG. 19. A force applied by a user's input in a block 242 is applied to a component of robotic device in a block 244. Encoders on the robotic device detect the direction and extent of the movement applied to the component of the robotic device and produce pulses indicative of the magnitude and indicating the direction or angle of the force. Frequency counters 246 and counters 248 count the frequency and pulses output from the encoders, producing signals that are input to a gravitation compensation module 250, and a virtual environment module 252. Also, force sensors on the robotic device detect the force applied by the user and produce output signals that are input to analog-to-digital (A/D) converters 254. The digital signals from the A/D converters are input to a digital signal processor 256, which produces digital control signals input virtual environment module 252. The signals and the output signals from the frequency counters and counters are all optionally input to a recording module 258, along with an output from the gravity compensation module. An output from the virtual environment module, which includes the display provided to the user, is input to the recording module and to digital-to-analog (D/A) converters 260, along with the output signal from the gravity compensation module. Analog signals from the D/A converters is amplified by amplifiers 262, to produce τ_{brakes} signals on a line 264 that is used to control the brake force experienced by the user, and τ_{gc} signals on a line 266 that is used to control gravity compensation by the robotic device.

### Exemplary Controller

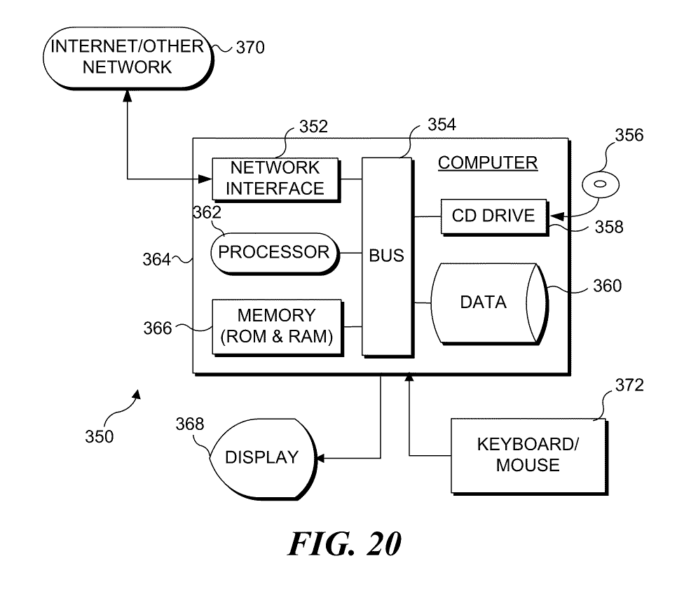

While a controller for the BAM or other robotic device that is used for interacting with a subject in connection with displaying a distorted virtual reality environment to a user can have other alternative forms, FIG. 20 provides a functional block diagram of an exemplary computing device 350 that can be employed for the controller. Alternative controllers include application specific integrated circuits, hardwired logic controllers, and other dedicated control and signal processing circuits. FIG. 20 schematically illustrates components of exemplary computing device 350, which includes a computer 364 suitable for implementing the present novel technique. Computer 364 may be a generally conventional personal computer (PC) such as a laptop, desktop computer, server, or other form of computing device. Computer 364 is coupled to a display 368, which is used for displaying the virtual environment in which one or more characteristics of the movement of a component are distorted, as described above.

Included within computer 364 is a processor 362; a memory 366 (with both read only memory (ROM) and random access memory (RAM)); a non-volatile storage 360 (such as a hard drive or other non-volatile data storage device) for storage of data and machine readable and executable instructions comprising modules and software programs, and digital data corresponding to other aspects of the virtual environment displayed to a user; an optional network interface 352; and an optical drive 358. These components are coupled to processor 362 through a bus 354. The data used in creating the virtual environment and other data can alternatively be stored at a different location and accessed over a network 370, such as the Internet, or a local or wide area network, through network interface 352. Optical drive 358 can read a compact disk (CD) 356 (or other optical storage media, such as a digital video disk (DVD)) on which machine instructions are stored for implementing the present novel technique, as well as machine instructions comprising other software modules and programs that may be run by computer 364. The machine instructions are loaded into memory 366 before being executed by processor 362 to carry out the steps for implementing the present technique, and for other functions. A user of the computing device (or the subject) can provide input to and/or control the processes that are implemented through keyboard/mouse 372, which is coupled to computer 364.

Although the concepts disclosed herein have been described in connection with the preferred form of practicing them and modifications thereto, those of ordinary skill in the art will understand that many other modifications can be made thereto within the scope of the claims that follow. Accordingly, it is not intended that the scope of these concepts in any way be limited by the above description, but instead be determined entirely by reference to the claims that follow.

The invention in which an exclusive right is claimed is defined by the following:

1. A method for enhancing an interaction of a user with a machine, comprising the steps of:
(a) enabling the user to control movement of a physical component of the machine, to accomplish a defined task;
(b) sensing the movement of the physical component caused by the user, producing a signal that is indicative of the movement;
(c) in response to the signal, displaying a virtual representation of the task to the subject;
(d) distorting one or more characteristics of the movement caused by the user in carrying out the task, as displayed to the user in the virtual representation, but to a degree limited such that distortion of the one or more characteristics is not perceived by the user; and
(e) encouraging the user to respond to the virtual representation for which the one or more characteristics were distorted, as viewed by the user, so that the user modifies the movement of the physical component based on a perception of the virtual representation by the user, due to the distortion of the one or more characteristics.

2. The method of claim 1, wherein the machine applies friction to resist the movement of the physical component by the user in at least one plane.

3. The method of claim 2, wherein the step of distorting the one or more characteristics comprises the step of distorting at least one characteristic selected from the group consisting of:
(a) applying either a positive or a negative gain to the displayed representation of the motion of the physical component in the virtual representation relative to an actual motion of the physical component caused by the user;
(b) creating a visual feedback distortion in the virtual representation in at least one dimension, to distort the movement being represented therein by creating a displacement between the representation of a position of the physical component in the virtual representation displayed and a position at which the physical component is actually disposed;
(c) creating the visual feedback distortion in the virtual representation using an illusory motion of an element displayed in the virtual representation; and
(d) creating the visual feedback distortion in the virtual representation by modifying motion of an element representing the physical component so that the element visually appears to be acted upon by a force that is actually different than a force applied to the physical component by the machine.

4. The method of claim 1, wherein the defined task corresponds to using the machine to assist the user in moving a physical load from one position to another, and wherein the user responds to the distortion of the one or more characteristics of the movement in the virtual representation by controlling the physical component to achieve the movement of the physical load, so that at least one attribute of the machine appears to be enhanced to the user based on the visual perception by the user of the movement that is displayed in the virtual representation.

5. The method of claim 1, wherein the step of distorting the one or more characteristics of the movement caused by the user comprises the step of distorting at least one characteristic selected from the group of characteristics consisting of:
(a) a speed of the movement visually displayed in the virtual representation;
(b) a velocity of the movement visually displayed in the virtual representation;
(c) an acceleration of the movement visually displayed in the virtual representation;
(d) a direction of the movement visually displayed in the virtual representation;
(e) an extent of the movement visually displayed in the virtual representation; and
(f) an illusory self movement of an element displayed in the virtual representation.

6. The method of claim 1, wherein the step of enabling the user to control movement of the physical component of the machine comprises the step of enabling the user to move the physical component with an appendage of the user.

7. The method of claim 1, further comprising the step of implementing the virtual representation of the movement as part of a game in which the user is participating, so that the user is more willing to carry out the defined task.

8. The method of claim 1, wherein the step of encouraging the user to respond to the virtual representation for which the one or more characteristics were distorted comprises the step of repetitively causing the user to visually perceive in the virtual representation that less movement of the physical component occurred than was actually the case, so that the user responds by exerting more force to move the physical component than the user would otherwise have applied, thereby increasing the strength and mobility of the user.

9. The method of claim 1, wherein the step of encouraging the user to respond to the virtual representation for which the one or more characteristics were distorted comprises the step of repetitively causing the user to visually perceive in the virtual representation that the representation of the movement of the physical component was in a different direction than the user actually moved the physical component, so that the user responds by changing the direction in which the user tries to move the physical component, thereby enabling the user to better move an appendage of the user's body in a desired manner.

10. A system for enhancing an interaction with a user, comprising:
(a) a movable component configured to be moved by a user when carrying out a defined task and having one or more sensors for detecting movement of the component by the user and producing an output signal indicative of the movement;
(b) a display configured to enable the user to view a virtual representation of the movement while the user is carrying out the task; and
(c) a controller coupled to receive the signal and operative to drive the display so that one or more characteristics of the movement are distorted when the virtual representation of movement caused by the user is displayed, but to a degree limited such that distortion of the one or more characteristics is not perceived by the user, and so that as the user views the virtual representation of the movement on the display, the user modifies the movement of the physical component based on a perception of the virtual representation by the user, due to the distortion of the one or more characteristics.

11. The system of claim 10, further comprising a brake that is applied by the controller to resist movement of the physical component by the user in at least one plane.

12. The system of claim 11, wherein the controller distorts the one or more characteristics by controlling at least one characteristic selected from the group of characteristics consisting of:
(a) either a positive or negative gain in regard to the displayed representation of the motion in the virtual representation relative to an actual motion of the physical component caused by the user;
(b) a visual feedback distortion in the virtual representation in at least one dimension, to distort the movement being represented therein by creating a displacement between the representation of a position of the physical component in the virtual representation that is displayed and a position at which the physical component is actually disposed;
(c) the visual feedback distortion in the virtual representation by creating an illusory motion of an element displayed in the virtual representation; and
(d) the visual feedback distortion in the virtual representation by modifying motion of the representation of the physical component as displayed, so that the element visually appears in the display to be acted upon by a force that is actually different than a force applied to the physical component by the brake.

13. The system of claim 10, wherein the system is being used to assist the user in moving a physical load from one position to another, and wherein the user responds to the distortion of the one or more characteristics of the movement in the virtual representation, by controlling the physical component to achieve the movement of the physical load, so that at least one attribute of the machine appears to be enhanced to the user, based on the visual perception by the user of the movement of the load that is displayed in the virtual representation.

14. The system of claim 10, wherein the controller distorts the one or more characteristics of the movement caused by the user by distorting at least one characteristic selected from the group of characteristics consisting of:
(a) a speed of the movement visually displayed in the virtual representation;
(b) a velocity of the movement visually displayed in the virtual representation;
(c) an acceleration of the movement visually displayed in the virtual representation;
(d) a direction of the movement visually displayed in the virtual representation;
(e) an extent of the movement visually displayed in the virtual representation; and
(f) an illusory self movement of an element displayed in the virtual representation.

15. The system of claim 10, wherein the physical component is configured to be moved by an appendage of the user.

16. The system of claim 10, wherein the controller implements the virtual representation of the movement as part of a game in which the user is participating, so that the user is more willing to carry out the defined task.

17. The system of claim 10, wherein the controller executes logic to control the virtual representation that is displayed to the user, so as to repetitively cause the user to visually perceive in the virtual representation that less movement of the physical component occurred than was actually the case, so that the user responds by exerting more force to move the physical component than the user would otherwise have applied, thereby increasing the strength and mobility of the user.

18. The system of claim 10, wherein the controller executes logic to control the virtual representation that is displayed to the user, so as to repetitively cause the user to visually perceive in the virtual representation that the representation of the movement of the physical component was in a different direction than the user actually moved the physical component, so that the user responds by changing the direction in which the user tries to move the physical component, thereby enabling the user to better move an appendage of the user's body in a desired manner.

19. The system of claim 10, wherein the physical component comprises an input device that is moved by the user to move a virtual object on the display, and wherein the one or more characteristics that are distorted cause the user to perceive that the virtual object on the display is moving in a manner such that the virtual object is either attracted or repelled from a position toward which the user is attempting to move the virtual object by controlling the input device.

20. The system of claim 10, wherein the one or more characteristics of the movement displayed in the virtual representation are distorted to redirect or manipulate an appendage of the user while the user is moving the physical component, to serve as a stimulus with visual feedback that modifies the interaction of the user with the physical component.
